(19) United States
(12) Patent Application Publication
(10) Pub. No.: US 2011/0246220 A1
(43) Pub. Date: Oct. 6, 2011

(54) Web Based Care Team Portal

(75) Inventor: Benjamin Albert, Evanston, IL (US)

(73) Assignee: REMCARE, INC., Skokie, IL (US)

(21) Appl. No.: 13/075,399

(22) Filed: Mar. 30, 2011

Related U.S. Application Data
(60) Provisional application No. 61/319,556, filed on Mar. 31, 2010.

(51) Int. Cl. G06Q 50/00; G06Q 10/00

(52) U.S. Cl. 705/2

(57) ABSTRACT

Implementations of the present disclosure provide a method for managing the care of a patient that includes receiving patient data including a patient condition at a computing device, where a portion of the patient data is transmitted to the computing device from a clinical information system over a network, determining a patient risk level based on the patient data, and generating a patient care plan based on the patient data that includes tasks based on the patient risk level. The method further includes receiving user input at the computing device, assigning members to a care team responsible for execution of tasks based on the user input, generating a required action corresponding to each task, transmitting the action to a computing device associated with a member responsible for execution of an action related task, and monitoring execution of the tasks based on task data received at the computing device.

### CROSS-REFERENCE TO RELATED APPLICATIONS

This application claims the benefit of U.S. App. No. 61/319,556, filed on Mar. 31, 2010, the disclosure of which is expressly incorporated herein by reference in its entirety.

### BACKGROUND

Upon discharge from a hospital, a patient may require additional follow-up care and monitoring on an outpatient basis. The implementation and coordination of a follow-up or post-discharge care plan for a discharged patient can be the responsibility of one or more members of the hospital staff. A physician determines a patient is ready for discharge and provides discharge orders along with a discharge note. The discharge note can include instructions for the patient's post-discharge care. A discharge nurse or hospital case manager assembles a post-discharge care plan and provides the plan to the patient at the time of discharge. It is then the patient's responsibility to follow the provided post-discharge care plan. Unfortunately, the patient may not have understood the plan at the time of discharge or possess the ability or the resources to accurately follow the post-discharge care plan. In some cases, this can result in the patient being readmitted to the hospital within thirty, sixty or ninety days of discharge for the same medical condition that required the previous admission or for a subsequent medical condition.

### SUMMARY

Implementations of present disclosure include methods for managing the care of a patient. In some implementations, a method includes receiving patient data at a computing device, the patient data including data regarding a condition of the patient and at least a portion of the patient data being transmitted to the computing device from a clinical information system over a network, determining a patient risk level based on the patient data, generating a patient care plan based on the patient data, the patient care plan comprising one or more tasks, the one or more tasks based on the patient risk level, receiving user input at the computing device, assigning a care team including one or more members based on the user input, each member responsible for execution of at least one of the one or more tasks, transmitting the at least one required action to a remote computing device associated with a member that is responsible for execution of a task related to the at least one required action, and monitoring execution of the one or more tasks based on task data received at the computing device.

In some implementations, the monitoring includes tracking completion of the one or more tasks based on the task data, the task data comprising one or more indictors related to performance of the one or more tasks, and generating a report, the report comprising resultant data related to the care of the patient.

In some implementations, the patient data further includes patient demographic data.

In some implementations, the method further includes receiving the demographic data from one of an admissions, discharges, and transfers (ADT) Health Level 7 (HL7) interface, a medications interface and a discharge summary interface.

In some implementations, the patient data further includes patient cognitive ability.

In some implementations, the method further includes determining a patient self care ability based on the patient data, where the patient care plan is determined based at least in part on the patient self care ability.

In some implementations, the monitoring includes receiving the task data as at least one of an electronic mail message, and a Short Message Service (SMS) message transmitted from the remote computing device.

In some implementations, the method further includes generating a reminder at the computing device based on a due date of at least one of the one or more tasks, and transmitting the reminder to the remote computing device over the network.

In some implementations, the method further includes generating an alert indicating that one or more of the tasks was not performed within a predetermined time, and displaying the alert at the computing device.

In some implementations, the care team includes one or more medical doctors, nurses, home healthcare nurses, community providers, community members or family members.

In some implementations, the care plan includes medication schedules, condition monitoring, physician appointments or patient education.

In some implementations, the patient data includes data manually entered into the computing device.

In some implementations, the patient is an inpatient in a hospital.

In some implementations, the patient care plan is a post-discharge care plan.

In some implementations, the method further includes assigning a case or care manager responsible for execution of the patient care plan based on user input received at the computing device.

In some implementations, the case manager is affiliated with a hospital responsible for care of the patient.

In some implementations, the method further includes generating resultant data including hospital readmission data.

In some implementations, generating the patient care plan includes selecting the patient care plan from a plurality of patient care plans stored in a computer-readable storage medium based on the patient data.

In some implementations, selecting the patient care plan includes selecting a care plan template based on one or more medical conditions also known as comorbidities.

In some implementations, generating the patient care plan includes modifying the patient care plan based on user input received at the computing device.

In some implementations, the method further includes selecting one or more of the members based on member data stored in a computer-readable storage medium.

Implementations of present disclosure include computer-readable storage device encoded with a computer program comprising instructions that, when executed, operate to cause one or more processors to perform the method for managing the care of a patient receiving patient data at a computing device.

Implementations of present disclosure include a system including one or more processors, and a computer-readable storage device coupled to the one or more processors having instructions stored thereon which, when executed by the one or more processors, causes the one or more processors to perform the method for managing the care of a patient receiving patient data at a computing device.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing a patient care plan and a care team connection portal. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is to say methods in accordance with the present disclosure are not limited to the combinations of aspects and features specifically described herein, but also include any combination of the aspects and features provided.

The details of one or more embodiments of the system are set forth in the accompanying drawings and the description below. Other features, objects, and advantages of the system will be apparent from the description and drawings, and from the claims.

### DESCRIPTION OF DRAWINGS

FIG. 1 is a block diagram of an example system architecture that can execute implementations of the present disclosure.

FIG. 2 is a flowchart illustrating example steps that can be executed in accordance with implementations of the present disclosure relating to a care team connection.

FIG. 3 is a flowchart illustrating example steps that can be executed in accordance with implementations of the present disclosure relating to a patient care plan.

FIG. 4 is a screen shot of an example web page for a hospital.

FIG. 5 is a screen shot of an example web page that includes a list of patients in a hospital ready for discharge.

FIG. 6 is a screen shot of an example web page that includes a pop-up window for assigning a case manager to one or more patients.

FIG. 7 is a screen shot of an example web page that includes an alternate pop-up window for assigning a case manager to one or more patients.

FIG. 8 is a screen shot of an example web page that includes a pop-up window for reassigning the case manager of one or more patients.

FIG. 9 is a screen shot of an example web page that includes an alternate pop-up window for reassigning the case or care manager of one or more patients.

FIG. 10 is a screen shot of an example web page that includes a pop-up window for a readmitted patient.

FIG. 11 is a screen shot of an example web page that includes a list of patients for a case manager.

FIG. 12 is a screen shot of an example web page that includes a patient profile.

FIG. 13 is a screen shot of an example web page that includes a clinical overview for a patient.

FIG. 14 is a screen shot of an example web page of a clinical overview for a patient that includes an add new condition drop-down menu.

FIG. 15 is a screen shot of an updated example web page of a clinical overview for a patient that includes an additional patient condition.

FIG. 16 is a screen shot of an example web page of a clinical overview for a patient that includes an add medication drop-down menu.

FIG. 17 is a screen shot of an example web page of a clinical overview for a patient that includes a hospital details drop-down menu.

FIG. 18 is a screen shot of an example web page of a risk profile and care plan selection for a patient.

FIG. 19 is a screen shot of an example web page for patient risk factor data entry.

FIG. 20 is a screen shot of an example web page for patient risk factor data entry that includes a pop-up warning message.

FIG. 21 is a screen shot of an example web page for care team member selection that includes a clinical member list and a family member list.

FIG. 22 is a screen shot of an example web page of care plan details for patient medications and allergies.

FIG. 23 is a screen shot of an alternate example web page of care plan details for patient medications and allergies.

FIGS. 24A-24J are screen shots of example web pages of a medication reconciliation management process for a patient.

FIG. 25A is a screen shot of an example web page of a care plan detail for patient symptom management.

FIG. 25B is a screen shot of an alternate example web page of a care plan detail for patient symptom management.

FIG. 26 is a screen shot of an example web page of a care plan detail that includes appointments and deliveries for the patient.

FIG. 27 is a screen shot of an example web page of a care plan detail that includes condition monitoring.

FIG. 28 is a screen shot of an alternate example web page of a care plan detail that includes condition monitoring.

FIG. 29 is a screen shot of an example web page of a care plan detail that includes equipment and supply management.

FIG. 30 is a screen shot of an example web page of a care plan detail that includes equipment and supply ordering and monitoring.

FIG. 31 is a screen shot of an example web page of a care plan detail that includes equipment and supply details.

FIG. 32 is a screen shot of an alternate example web page of a care plan detail that includes equipment and supply details.

FIG. 33 is a screen shot of an example an example web page for patient resources.

FIG. 34 is a screen shot of an example web page for patient education materials.

FIG. 35 is a screen shot of an example web page for review of a care plan.

FIG. 36 is a screen shot of an alternate example web page for review of a care plan.

FIG. 37 is a screen shot of an example web page for a home web page for a case manager.

FIG. 38 is a screen shot of an example web page for an inbox for a case manager.

FIG. 39 is a screen shot of an example web page that lists reminders and alerts for a case manager.

FIG. 40 is a screen shot of an alternate example web page that lists reminders and alerts for a case manager.

FIG. 41 is a screen shot of an example web page that includes a medication list for a patient.

FIG. 42A is a screen shot of an example web page that shows a care plan summary for a patient.

FIG. 42B is a screen shot of an alternate example web page that shows a care plan summary for a patient.

FIG. 43 is a screen shot of an example web page that includes detailed information associated with a task.

FIG. 44 is a screen shot of an example web page that includes information for one or more care team members.

FIG. 45 is a screen shot of an example web page for a family portal.

FIG. 46 is a screen shot of an example web page that includes an outcome report for patient readmissions.

FIG. 47 is a screen shot of an example web page that includes a readmission summary for patient readmissions.

FIG. 48 is a screen shot of an example web page that includes a condition summary for patient readmissions.

FIG. 49 is a screen shot of an example web page that includes a case status report for patient readmissions.

FIG. 50 is a screen shot of an example web page that includes a contact history report.

FIG. 51A is a chart of an example of a user type overview.

FIG. 51B is a chart of an example listing of office member types.

FIGS. 51C-51V are screen shots of example web pages for adding and managing care team members and resources.

FIG. 52 is a schematic illustration of exemplar computer systems that can be used to execute implementations of the present disclosure.

Like reference symbols in the various drawings indicate like elements.

### DETAILED DESCRIPTION

In general, one aspect of health care reform is the reduction of unnecessary and preventable medical expenses. The reduction of preventable hospital readmissions can reduce medical expenses. In order to achieve this, a hospital can connect a patient and coordinate care with the community care world available to the patient at the time of their discharge. This connection can include the necessary logic and case or care management needed in order to transition the patient out of the hospital and back into a more independent home care setting (e.g., the patient's home or assisted living facility). This can involve the sharing and monitoring by a community care team (e.g., primary care physicians, specialists, nurses, social workers, family members, etc.) of the information needed to support the patient post-discharge as they transition from the hospital to their home care setting. In some cases, the support required can be based on the current condition of the patient. The condition of the patient can include their physical condition, their medical condition and their mental and emotional condition. In an example of a post-discharge plan, the plan can use one or more factors to determine the condition of the patient. The factors can include, but are not limited to, the acuity level of the patient, the ability of the patient to care for themselves (e.g., personal hygiene, mobility, etc.), the cognitive ability of the patient, the primary language spoken by the patient, and the diagnosed number of concurrent medical conditions the patient may suffer from.

In some implementations, the hospital can create a post-discharge care plan that includes instructions for each care team member. In an example of the creation of a care plan, a case administrator in a hospital, upon notification of the discharge of a patient, assigns a case manager to the patient and creates a post-discharge care plan. The care plan includes one or more community care team members each of which has a role in the post-discharge care of the patient. In some implementations, the care plan is based on a template where the template used for the patient care plan is determined based on the patient's one or more active medical conditions (e.g., congestive heart failure, diabetes, post acute myocardial infarction, pneumonia, Alzheimer's disease, etc.). The use of a care plan by the community care team members allows each care team member to be informed of the condition of the patient and to share information related to the condition of the patient.

In some implementations, a secure and configurable care team connection portal connects care team members, and allows them to access and share the care plan for a patient. The care team can collaborate to manage the post-discharge care of the patient. The care plan educates the care team with real time quantitative and qualitative information allowing each care team member to make informed decisions concerning the post-discharge care of the patient. Additionally, the care team connection portal provides a platform for the distribution of additional information, including but not limited to, educational materials, and resources and products to assist in the post-discharge care of the patient. The care team connection portal can track compliance with the care plan and assess the risk factors of the patient.

In general, the care team connection portal can be used to strengthen the communication between care team members resulting in reduced healthcare costs and improved patient outcomes. The use of a care team connection portal by care team members to manage the post-discharge care of a hospital patient can reduce the preventable readmission rates for the hospital. In some cases the government and insurance companies may no longer reimburse the hospital for what they consider preventable readmissions (e.g., readmitting a patient to the hospital within thirty days of discharge) forcing the hospital to provide costly patient care that is not fully reimbursed. The reduction in preventable readmissions, specifically within a predetermined time period (e.g., thirty days after discharge), can reduce hospital costs.

In some implementations, the care team connection portal is a web-based platform accessible by each care team member that includes a risk stratification tool. The risk stratification tool allows care team members, specifically case administrators and case managers (care managers), to assign a risk profile to each patient. For example, the risk stratification tool can use patient data related to the current physical and mental health of the patient to determine a risk profile. The ability to identify high risk and low risk patients can allow the sometimes limited resources of the hospital and the community care team to be focused on the patients with the most need.

In some implementations, the care team connection portal includes patient-specific care plans. Case administrators and case managers can create a patient-specific care plan that includes specific tasks to be performed for the individual patient based on their physical condition, living situation and risk profile. For example, a care plan for a patient living alone can include the coordination of transportation when needed for outside appointments. Care team members can manage the patient-specific care plan. For example, a family member who is a member of the care team may be responsible for providing the needed transportation for the patient.

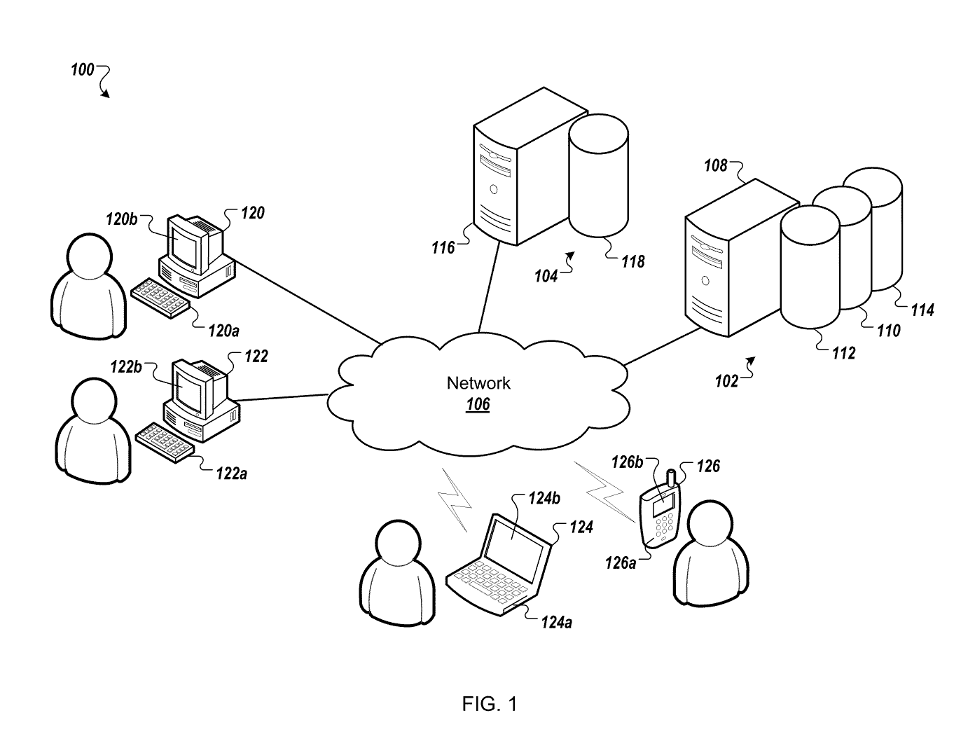

FIG. 1 is a block diagram of an example system architecture 100 that can execute implementations of the present disclosure. Referring to FIG. 1, the architecture 100 includes a hospital computer system 102, a care plan computer system 104, and a network 106. The hospital computer system 102 includes a hospital server 108, a clinical information system (CIS) database 110, a physician credentials database 112 and a patient discharge information database 114.

The hospital server 108 can host applications for use in managing patient care in a hospital. The applications can access the CIS database 110 that includes patient demographic data (e.g., address, phone numbers, age, etc.). The physician credentials database 112 can include the names of physicians in the local community affiliated with the hospital that have preferred patients or rights within the hospital. The discharge information database 114 can include specific discharge information for a patient when discharged from the hospital. The discharge information can be provided to the patient upon discharge.

The care plan computer system 104 can include a web server 116 and a care plan database 118. The web server 116 can host a care plan management application that can provide a centralized web portal for the management of post-discharge patient care. The care plan database 118 can be a repository for patient care plans. The care plan computer system 104 can communicate with the hospital computer system 102 by way of network 106. The care plan computer system 104 can receive patient information that includes, but is not limited to, patient demographics, discharge plan instructions and patient care team members. The patient information can be included in a care plan hosted by the web server 116 and stored in the care plan database 118.

The architecture 100 includes user access devices 120, 122, 124, 126. For example, the user access device 120 can be an internal client computer system located within the same hospital that includes the hospital computer system 104. The user access device 120 can communicate with the hospital computer system 102 by way of network 106. An example use of the user access device 120 is a hospital case administrator entering patient demographic data into the user access device 120 using keyboard 120a.

The hospital server 108 can receive the patient data from the user access device 120 by way of network 106. The hospital server 108 can store the patient data in the CIS database 110. In another example of the use of the user access device 120, the hospital case administrator enters discharge plan data for a patient into the user access device 120 using keyboard 120a. The hospital server 108 receives the discharge plan data from the user access device 120 by way of network 106. The hospital server 108 can store the discharge plan data in discharge information database 114.

In some implementations, the user access device 122 is an external client computer system located outside of the hospital that includes the hospital computer system 104. An example use of the user access device 122 is a case manager remotely accessing the care plan computer system 104, by way of network 106 using user access device 122, to review a patient's care plan. The case manager can access a centralized web portal hosted on the web server 116. The case manager can enter their login credentials using keyboard 122a in order to retrieve the care plan for a patient from the care plan database 118 included in the care plan computer system 104. The care plan computer system 104 can send the data for the care plan for the patient to the user access device 122 by way of network 106. Display device 122b can display the care plan data to the case manager for review.

In some implementations, user access device 124 communicates with the care plan computer system 104 wirelessly by way of network 106. An example use of the user access device 124 is a physician accessing the care plan computer system 104 to review a patient's care plan. The physician accesses a centralized web portal hosted on the web server 116. The physician can enter their login credentials using keyboard 124a in order to retrieve the care plan for their patient from the care plan database 118 included in the care plan computer system 104. The care plan computer system 104 can send the data for the care plan for the patient to the user access device 124 by way of network 106. Display device 124b can display the care plan data to the physician for their review.

In some implementations, the user access device 126 can communicate with the care plan computer system 104 wirelessly by way of network 106. An example use of user access device 126 is a family member (e.g., a son, daughter, husband, wife, etc.) accessing the care plan computer system 104 to review a care plan for another family member. The family member accesses a centralized web portal hosted on the web server 116. The family member can enter their login credentials using keyboard 126a in order to retrieve the care plan for their family member from the care plan database 118 included in the care plan computer system 104. The care plan computer system 104 can send the data for the care plan for the family member to the user access device 126 by way of network 106. Display device 126b can display the care plan data to the family member.

In some implementations, the care plan computer system 104 sends notices or alerts to one or more care plan team members. The alerts can indicate patient tasks that require immediate attention (e.g., a missed doctor's appointment, a lapsed medical assessment, an overdue prescription refill, etc.). For example, the care plan computer system 104, using network 106, can send alerts to one or more care plan team members who can receive and review the alerts using user access devices 120, 122, 124, 126. The alerts can be an electronic communication (e.g., an electronic mail (email) message, a Short Message Service (SMS) text message, a voice mail message, etc.). The form of the electronic communication can be dependent on the type of user access device receiving the message (e.g., a cell phone can receive a voice mail message, a personal digital assistant (PDA) can receive an email message, etc.).

In some implementations, the web server 116 can include an analytics tool that can generate one or more reports using patient care plan data. For example, the analytics tool can determine the readmission rate of patients whose data is stored in the care plan database 118. The analytics tool can present the readmission rates for patients based on one or more factors included in the patient care plans (e.g., age, medical condition, ethnicity, risk profile, etc.) The care plan computer system 104, using network 106, can provide the reports generated by the analytics tool to the user access devices 120, 122, 124, 126 for display on display devices 120b, 122b, 124b, 126b, respectively.

Referring again to FIG. 1, the systems and devices included in the architecture 100 are coupled to the network 106. Each of the systems 102, 104 and devices 120, 122, 124, 126 in FIG. 1 may be implemented or associated with hardware components, software components, or firmware components, or any combination of such components. For example, the network 106, the systems 102, 104 and the devices 120, 122, 124, 126 may be implemented or associated with general purpose servers, clients, software processes and engines, and/or various embedded systems.

The architecture 100 includes one or more user access devices 120, 122, 124, 126 and computer systems 102, 104. In some implementations, the architecture 100 represents a client/server system supporting multiple computer systems including one or more clients (e.g., user access device 120 can serve as a client) and/or one or more servers (e.g., server 108, server 116) that are connectively coupled for communication with one another over a network 106. In some implementations, the clients are directly connected to the one or more servers (without connecting by way of network 106).

The user access devices 120, 122, 124, 126 may include devices capable of receiving information from the network 106. The user access devices 120, 122, 124, 126 can represent various forms of processing devices including, but not limited to, a general purpose computer, a special purpose computer, a desktop computer, a laptop computer, a handheld computer, a personal digital assistant (PDA), a tablet computer, a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. In addition, each user access device (e.g., user access devices 120, 122, 124, 126) may access application software on the each of the servers (e.g., server 108 and server 116).

The servers 108, 116 can represent various forms of servers including, but not limited to, a web server, an application server, a proxy server, a network server, or a server farm. For example, the servers 108, 116 can be application servers that execute software accessed by user access devices 120, 122, 124, 126. In operation, multiple user access devices 120, 122, 124, 126 can communicate with the servers 108, 116 by way of network 106. In some implementations, architecture 100 may enable a user to invoke applications available on the servers 108, 116 using a web browser running on one of the user access devices 120, 122, 124, 126. Each application can individually access data from one or more repository resources (e.g., databases 118, 110, 112, 114). For example, the server 108 accesses databases 110, 112, 114. For example, server 116 accesses database 118.

In some implementations, the user access devices 120, 122, 124, 126 communicate wirelessly through a communication interface (not shown), which may include digital signal processing circuitry where necessary. The communication interface may provide for communications under various modes or protocols, such as Global System for Mobile Communications (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Private Data Channel (PDC), Wideband Code Division Multiple Access (WCDMA), Code Division Multiple Access 2000 (CDMA2000), or General Packet Radio Service (GPRS), among others. For example, the communication may occur through a radio-frequency transceiver (not shown). In addition, short-range communication may occur, such as using a Bluetooth (e.g., I8 802.15x), WiFi (e.g., 802.11x), or other such transceivers.

In some implementations, the architecture 100 is a distributed client/server system that spans one or more networks such as network 106. The network 106 can be a large computer network, such as a local area network (LAN), wide area network (WAN), the Internet, a cellular network, or a combination thereof connecting any number of mobile clients, fixed clients, and servers. In some implementations, each of the user access devices 120, 122, 124, 126 communicates with each of the servers 108, 116 via a virtual private network (VPN), Secure Shell (SSH) tunnel, or other secure network connection. In some implementations, the network 106 includes the Internet, a wireless service network and may include the Public Switched Telephone Network (PSTN). In other implementations, the network 106 includes a corporate network (e.g., an intranet) and one or more wireless access points.

Each of the user access devices 120, 122, 124, 126 can establish its own session with each of the servers 108, 116. Each session can be semi-permanent as it can be established at one point in time and torn down at another. Each session can involve two-way information exchange between each of the computer systems 102, 104 and each individual user access device 120, 122, 124, 126. For example, a Hypertext Transfer Protocol (HTTP) session enables the association of information with individual users. One or more of the user access devices 120, 122, 124, 126 can communicate via network 106 with each of the servers 108, 116. In order to run an application, each user access device 120, 122, 124, 126 can establish a corresponding session with each of the servers 108, 116.

In some implementations, the hospital computer system 102 can provide patient data directly to the care plan computer system 104 by way of network 106. For example, the care plan computer system 104 can receive an admissions, discharges, transfers (ADT) feed from the hospital computer system 102. The ADT feed is a streamlined way of getting messages that include patient demographics from a hospital information system (HIS) (e.g., hospital computer system 102) to an application or provider outside of the HIS. In some implementations, the ADT feed can be a Hospital Language 7 (HL7) standard formatted message.

In some implementations, the care plan computer system 104 can receive information from home care scheduling and documentation systems by way of network 106. The home care scheduling and documentation systems can provide information related to available home care resources for the patient.

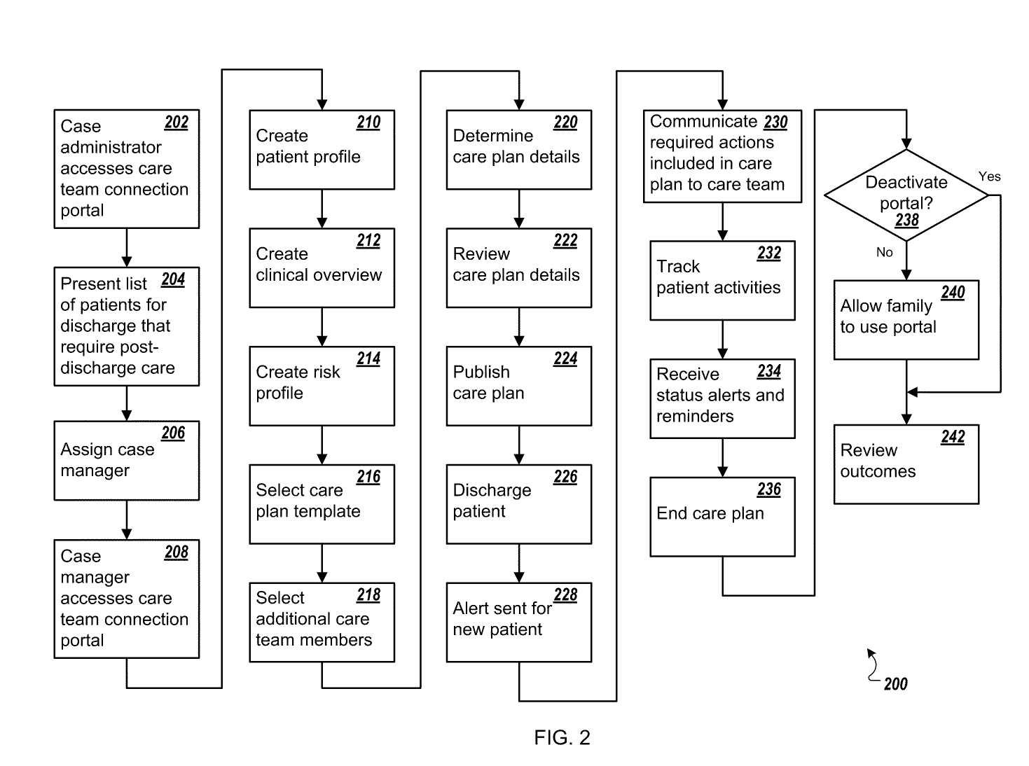

FIG. 2 is a flowchart illustrating example steps 200 that can be executed in accordance with implementations of the present disclosure relating to a care team connection. For example, the example steps of FIG. 2 may be implemented using software instructions stored in a computer-readable storage medium and executed by a processing system including one or more processing apparatus, or processors.

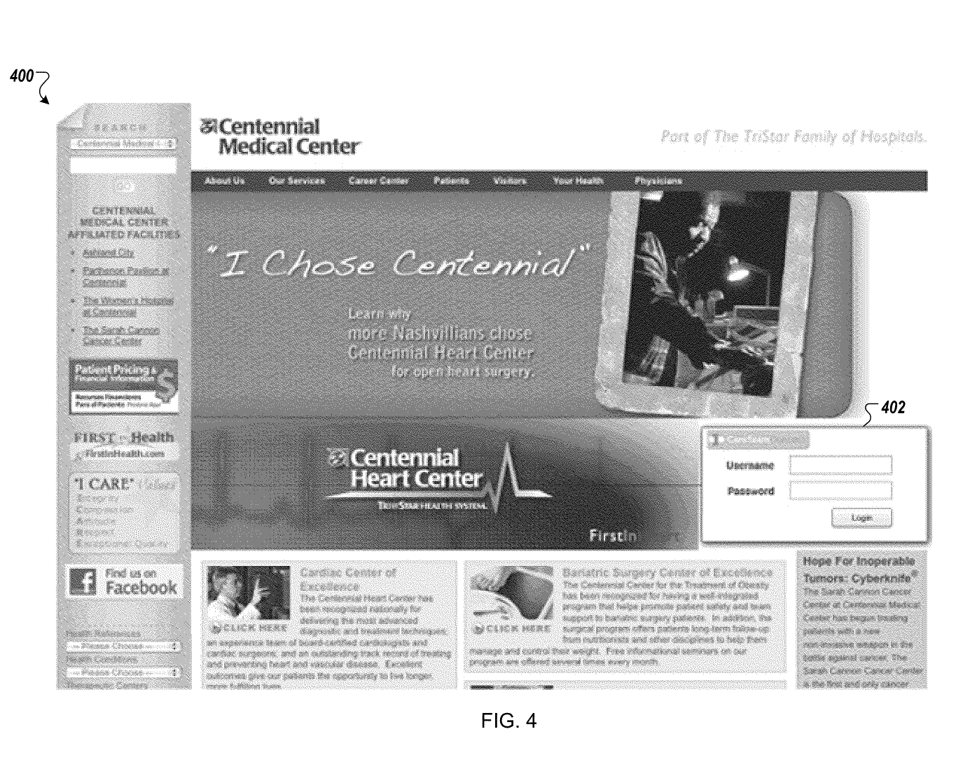

Referring to FIG. 2, the steps 200 are used in the creation, management and execution of a care team connection process. A case administrator accesses the care team connection portal (step 202). For example, the case administrator can navigate to a web page 400 for a hospital, as shown in FIG. 4 that includes a login window that allows the case administrator to enter their credentials in order to login to the care team connection portal associated with the hospital. In some implementations, the case administrator may be an individual (e.g., a nurse or social worker) within a hospital assigned with the task of creating a care plan for a discharged patient. In some implementations, the case administrator may be an individual contracted by the hospital whose job is to manage the creating of a care plans for patients discharged from the hospital.

For example, referring to FIG. 1, the care team connection portal is hosted on the web server 116. The case administrator uses user access device 120 to access the hospital computer system 102 to display web page 400 on display device 120b.

The hospital computer system 102 can provide an ADT feed of patient data from the hospital computer system 102 to the care plan computer system 104. The care plan computer system 104 can analyze the patient data to determine of the patients being discharged, which patients will require post-discharge care. In some implementations, the care plan computer system 104 uses an algorithm that assigns a risk level to a patient dependent on one or more criteria. The criteria can include, but are not limited to, the acuity level of the patient, the ability of the patient to care for themselves (e.g., personal hygiene, mobility, etc.), the cognitive ability of the patient, the mental health of the patient, the primary language spoken by the patient, and the diagnosed number of concurrent medical conditions the patient may suffer from. The algorithm identifies patients whose calculated risk level exceeds a particular predetermined threshold as requiring post-discharge care. The risk factors used to determine the patient criteria for post-discharge care may be based on patient data related to readmissions. For example, patients with congestive heart failure who additionally suffer from dementia may exhibit a high readmission rate and therefore would benefit from post-discharge care.

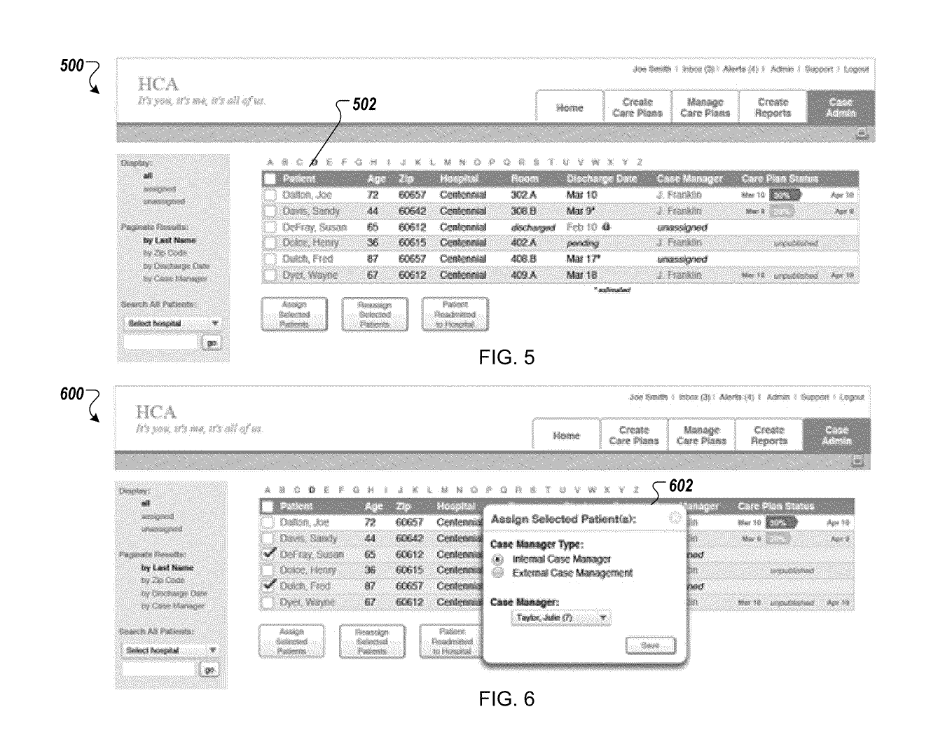

Once the case administrator logs into the care team connection portal, the case administrator is presented with a list of the patients within the hospital that are ready for discharge and require post-discharge care (step 204). For example, the case administrator is presented with web page 500 shown in FIG. 5 on display device 120b that includes a list of patients in the hospital ready for discharge that require post-discharge care. The patient list can include an estimated discharge data for a patient. The patient list can indicate that the hospital discharged the patient. The patient list can indicate if the case administrator has previously assigned a case manager to a patient.

The case administrator assigns a case manager or coach to a patient ready for discharge (step 206) if they currently do not have an assigned case manager. For example, the case administrator selects one or more patients to assign to a case manager. Referring to FIG. 6, the display device 120b displays a web page 600 to the case administrator. The case administrator can select the check box next a patient's name for one or more patients and select to assign the one or more patients to a case manager. As shown in FIG. 6, a pop-up window 602 appears allowing the case administrator to select and assign a case manager to the patient. In some implementations, the case administrator selects a case manager from a list of case managers. Included in the selection of the case manager can be an indication of the current number of patients assigned to the case manager. For example, a case administrator can attempt to assign equally patients to case managers in order to avoid overloading a single case manager with the majority of the patients. In some implementations, the case administrator can select the case manager type. For example, a case manager may be an internal case manager associated with and employed by the hospital. In another example, the case manager can be an external case manager associated with an outside agency contracted by the hospital. For example, the case manager may be an external case manager contracted directly by the hospital.

In some cases, the patient may be ready for immediate discharge. In other cases, the hospital may discharge the patient at a later predetermined date. In some cases, the predetermined date is an estimated date subject to change.

A case administrator can use one or more criteria to determine the assigning of a particular case manager to a patient. For example, a case administrator can assign patients in a defined geographic location to a specific case manager. The case manager may be located within the same defined geographic location. This can have the benefit of a case manager that has easy access to their assigned patients. For example, a case administrator can assign patients diagnosed with a particular medical condition to a specific case manager that has prior training and experience in caring for patients with that particular medical condition. In some implementations, a case administrator can reassign one or more patients from one case manager to another. Display device 120b can display example web page 800 shown in FIG. 8. The web page 800 can allow the case administrator to reassign one or more selected patients from one case manager to another. For example, the case administrator may want to reassign patients among the case managers in order to balance the patient load for each case manager.

In the example of FIG. 10, a web page 1000 can indicate if a current hospital patient ready for discharge was ever previously treated at the hospital (the hospital readmitted the patient). If the patient was readmitted during the execution of a care plan created when they were last discharged, the case administrator can choose to stop or cancel the care plan for that particular patient.

A case manager accesses the care team connection portal (step 208). For example, referring to FIG. 1 and FIG. 4, using user access device 122, the case manager can navigate to the web page 400 for a hospital that can be displayed on display device 122b. The web page 400 includes a login window that allows the case manager to enter their credentials in order to login to the care team connection portal associated with the hospital and hosted on the web server 116.

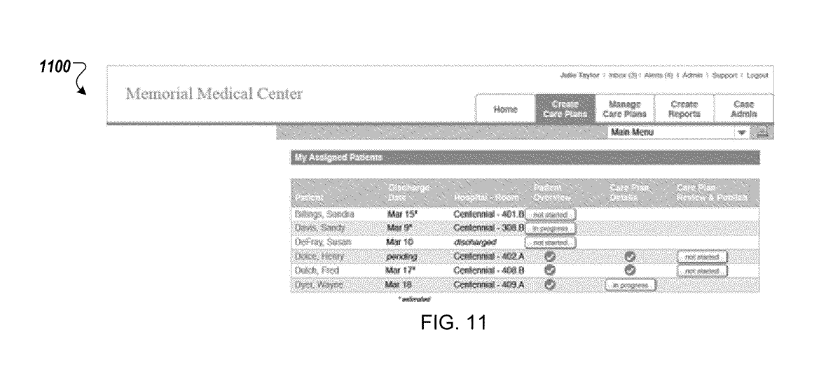

Once logged in to the care team connection portal, the case manager is presented with a list of their assigned patients as shown in web page 1100 in FIG. 11. The patient list can include information relative to the patient regarding their care plan. For example, the case manager can select a patient and review the progress of their current care plan.

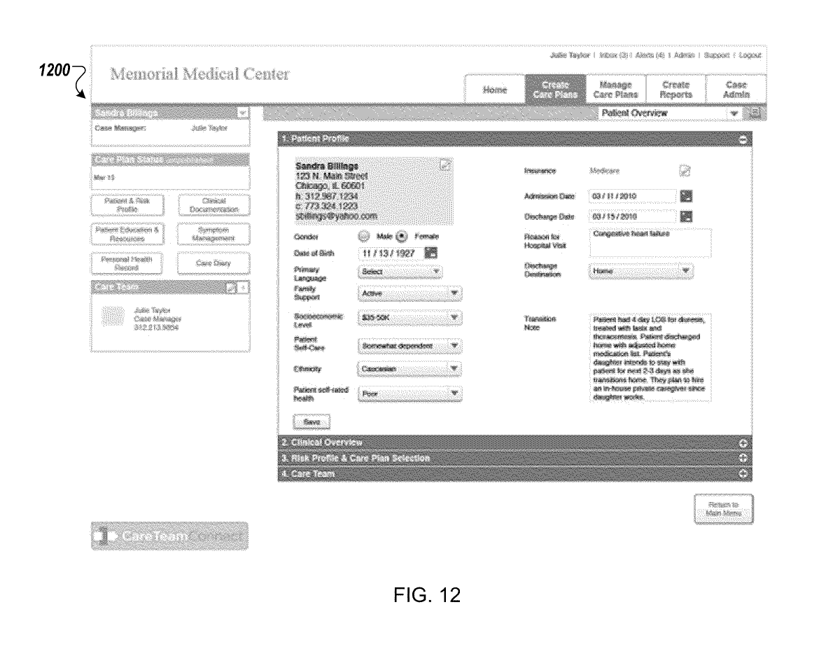

The case manager creates a patient profile (step 210). FIG. 12 shows an example of a web page 1200 of a patient profile. The patient profile can be populated with data received from the hospital computer system 102 and stored in the care plan database 118. In some implementations, the case manager can manually enter missing or additional patient data using keyboard 122a on user access device 122. The patient data can include, but is not limited to, the patient's address, phone numbers, gender, birth date, type of medical insurance, hospital admission date, and hospital discharge date. Additional data can include information related to the overall health and well-being of the patient (e.g., patient self-care rating, primary language, socioeconomic level, etc.). The case manager can use the patient data to determine the type of care plan for the patient and the risk level of the patient. Additionally, the case manager can enter a transition note that includes helpful information for the members of the care team related to the post-discharge care of the patient. The care plan computer system 104 can combine the information provided by the hospital computer system 102 with the information entered by the case manager and store it for the patient in the care plan database 118.

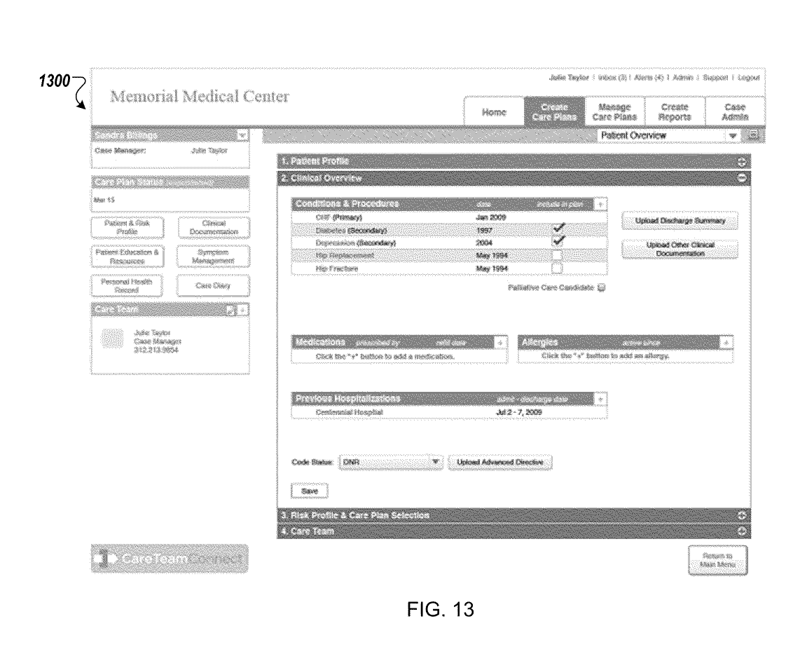

A case manager creates a clinical overview (step 212). FIG. 13 shows an example of a web page 1300 of a patient's clinical overview. The information included in the patient's clinical overview may be populated with data received from the hospital computer system 102 and stored in the care plan database 118. The clinical data for the patient can include, but is not limited to, the patient's current medical conditions (e.g., diabetes, congestive heart failure (CHF), pneumonia, acute myocardial infarction), medical procedures the patient has previously undergone (hip replacement, double bypass surgery, etc.), current prescribed medications, allergies, previous hospitalizations, and a code status (e.g., do not resuscitate (DNR), full code, etc.).

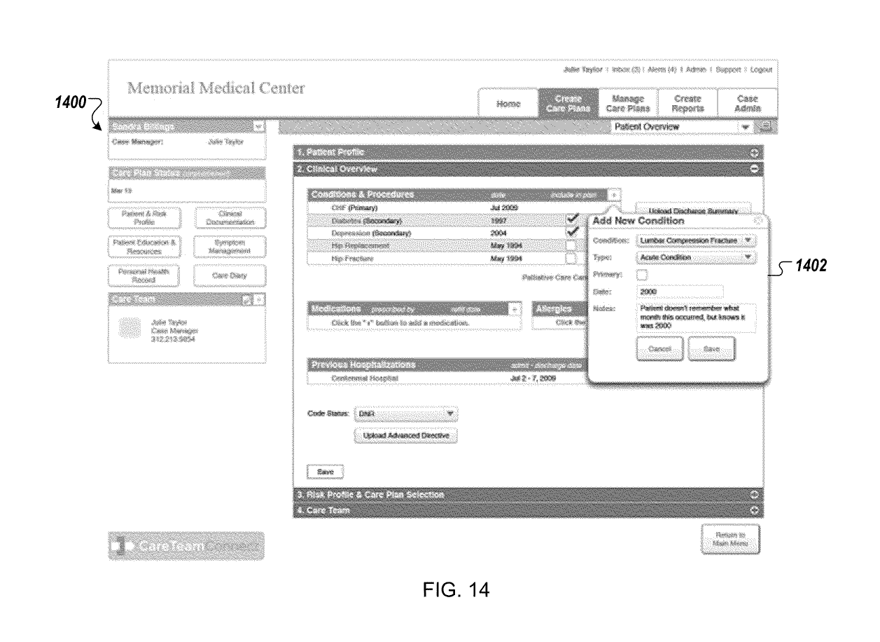

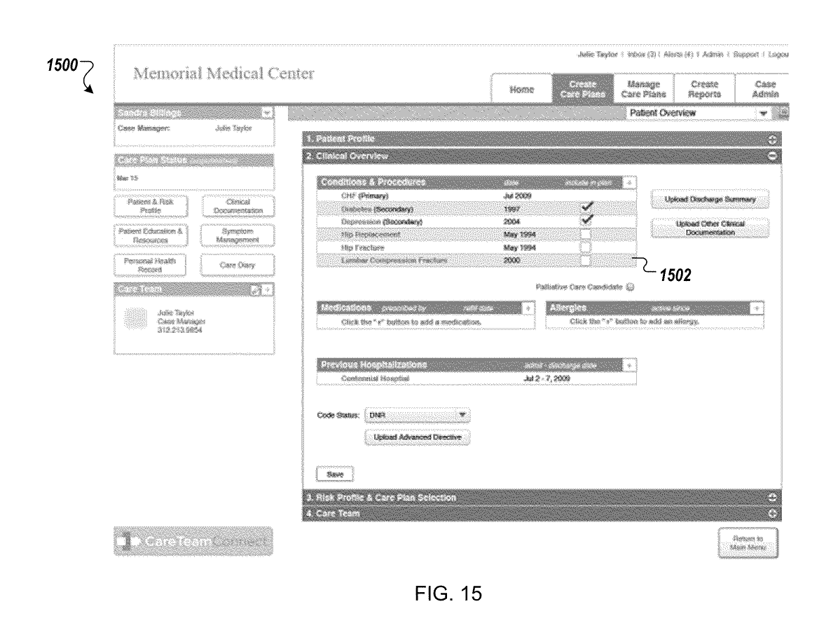

In some implementations, the case manager manually enters missing or additional clinical data for the patient using keyboard 122a on user access device 122. For example, the case manager can enter a condition or procedure for the patent as shown in FIG. 14 where a web page 1400 includes a drop-down menu the case manager can interact with using user access device 122 to enter the condition and condition type (e.g., acute, chronic, etc.). The newly added condition can then be included in the clinical overview as shown on a web page 1500 in FIG. 15.

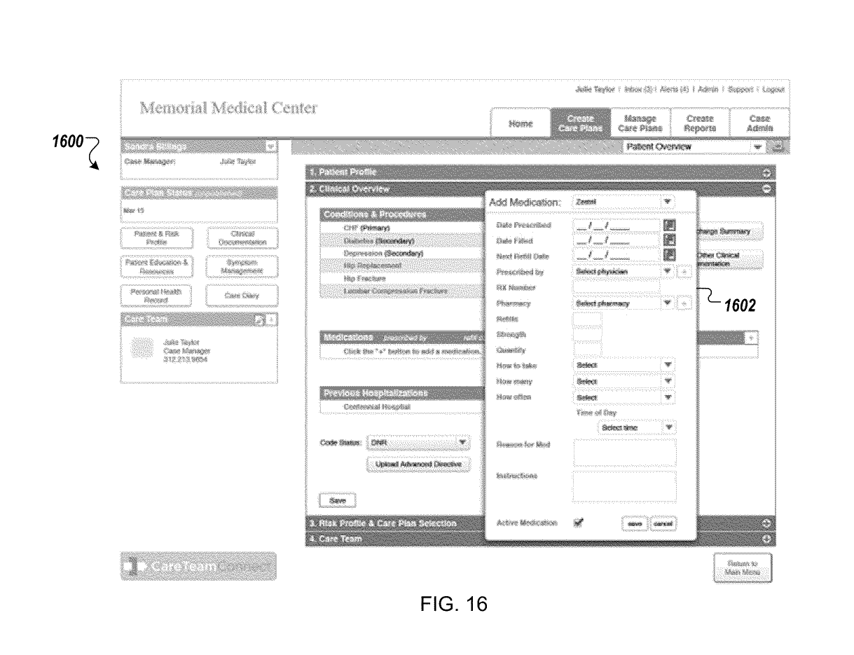

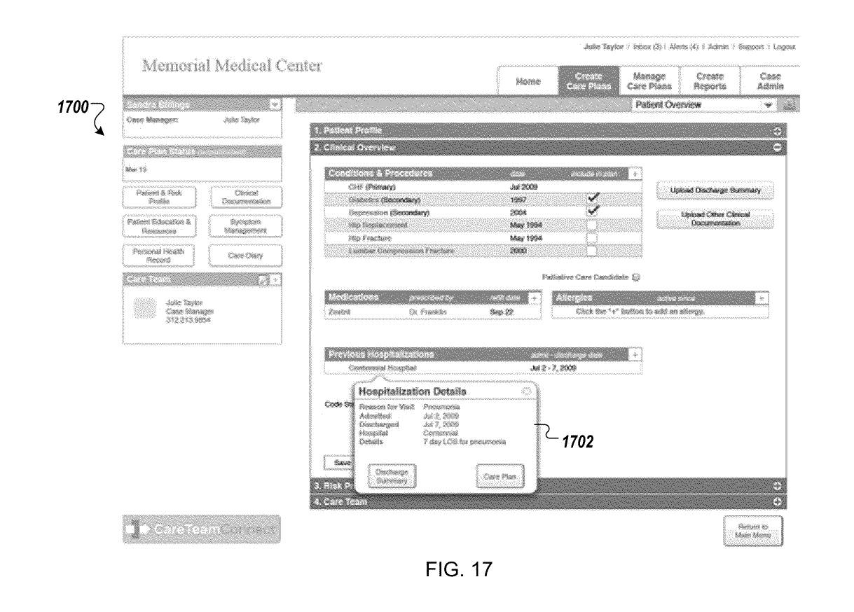

For example, the case manager can enter a medication for the patent as shown in FIG. 16 where a web page 1600 includes a drop-down menu the case manager can interact with using user access device 122 to enter the medication type along with relevant date and dosage information. For example, the case manager can enter details related to the patient's previous hospitalizations as shown in FIG. 17 where a web page 1700 includes a drop-down menu the case manager can interact with using user access device 122 to enter the hospitalization details. The patient's clinical overview will be updated with the data entered by the case manager. The care plan computer system 104 can update the information regarding the patient's clinical overview with the information provided by the case manager and store the updated patient clinical overview in the care plan database 118.

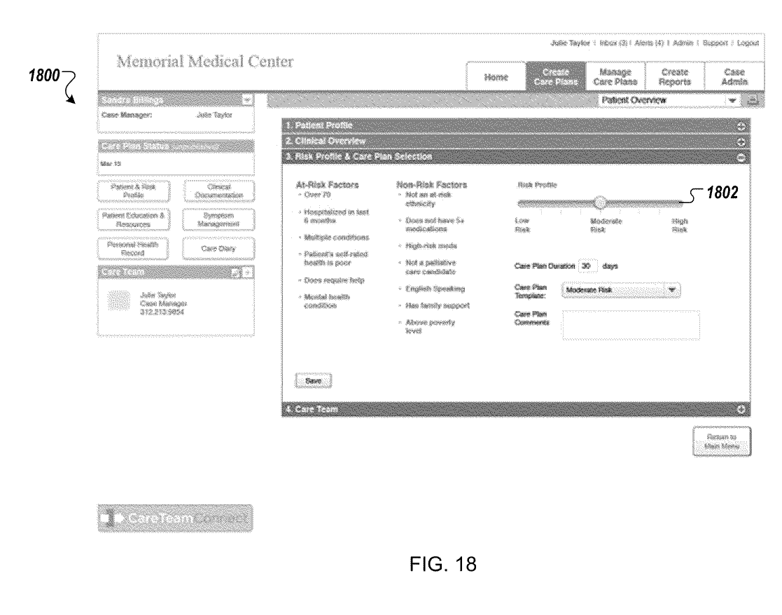

A case manager creates a risk profile (step 214). The risk profile can be used to determine the risk of the patient for readmission to the hospital within a predetermined number of days (e.g., thirty) after their discharge. For example, the care plan computer system 104 can use a risk algorithm (e.g., a risk stratification tool) to determine a risk profile for a patient. The risk algorithm can use the number and type of risk factors for a patient to determine the patient's risk profile. The risk profile can be on a scale from low risk to high risk for readmission. For example, risk factors used by the risk algorithm can include, but are not limited to: age, the number of past hospitalizations, the number and type of preexisting medical conditions, the patient self care rating, the patient's mental health condition, the number of medications the patient is taking, the ethnic background of the patient, the primary language spoken by the patient, the socioeconomic status of the patient, and whether the patient has family support. For example, web page 1800 in FIG. 18 shows a risk profile 1802 for a patient.

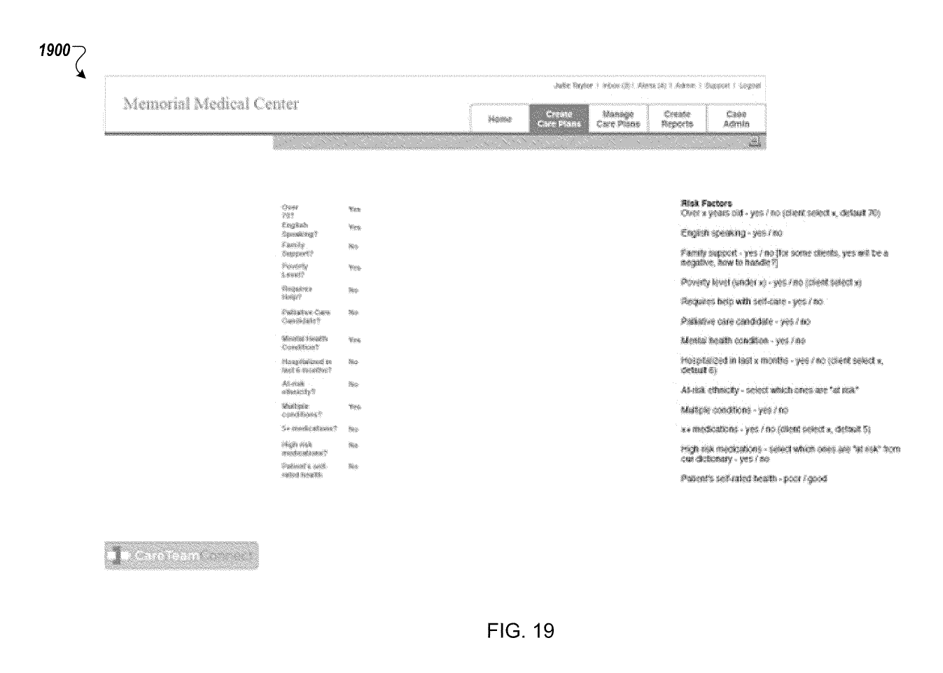

In some implementations, the case manager manually enters the risk factors for the patient using keyboard 122a on user access device 122. For example, the web server 116 can present the case manager with a web page 1900, as shown in FIG. 19 that allows the case manager to enter risk factor information for a patient. The display device 122b can display the web page 1900 to the case manager. The case manager can provide answers to the risk factor questions that can be used to determine the risk profile for the patient. In some implementations, the case manager may provide risk factor information in the form of a patient data file sent from the user access device 122 to the care plan computer system 104.

In some implementations, a case manager can assign a weight factor to one or more of the patient risk factors. The risk algorithm can use the weight factors associated with each risk factor in determining a risk profile for a patient. For example, from prior experience and accumulated data, the case manager determines that the socioeconomic status of the patient plays a large part in the determination of their subsequent probability for readmission. A patient with a low socioeconomic status has a much greater probability for readmission than a patient with a high socioeconomic status. The case manager can weigh the risk factor for the socioeconomic status of the patient.

The case manager selects a care plan template (step 216). The care plan is created using the selected template. The care plan is in effect for the number of days entered by the case manager for the care plan duration (e.g., thirty days). The case manager can select the care plan template based on the patient's risk profile. The care plan template can include the tasks and care plan team members needed to provide the appropriate post-discharge care for the patient based on the patient's risk profile. Basing the care plan template on the risk profile of the patient insures the appropriate allocation of resources for the patient. For example, a patient requires a follow-up visit with their primary care physician seven days after they are discharged from the hospital. When creating a care plan for a low risk profile patient, the case manager can select a low risk care plan template. The case manager, using the low risk care plan template, can assign the task of scheduling the follow-up visit to the staff at the physician's office. A staff member can telephone the patient, set up the appointment with the patient and the staff member can add the appointment to the patient's care plan. A low risk profile patient can be involved in the management of their care plan. Alternately, when creating a care plan for a high risk profile patient, the case manager can select a high risk care plan template. The case manager, using the high risk profile template, can take on the task of scheduling the follow-up visit. The case manager can call the physician's office, schedule the follow-up appointment, add the appointment to the care plan and inform the patient of the follow-up appointment, leaving none of the responsibility for appointment scheduling to the patient.

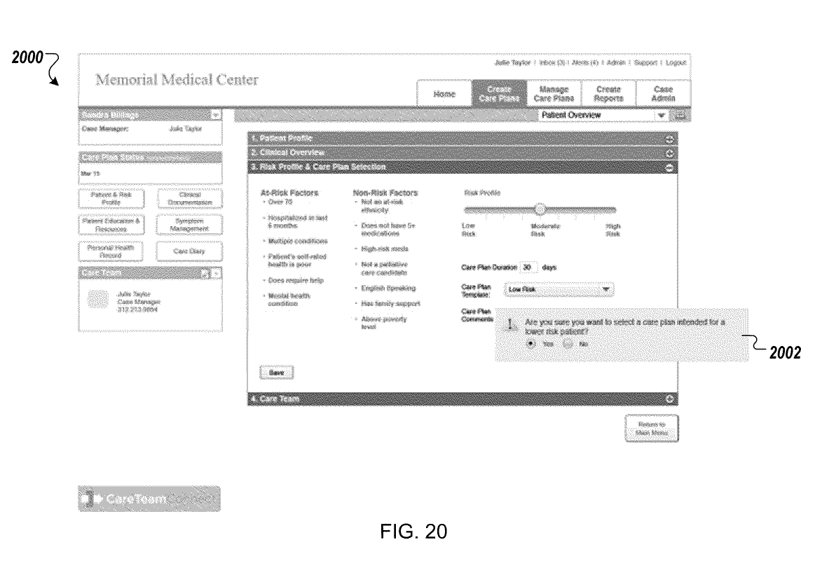

In some implementations, the case manager includes care plan comments in the patient's risk profile and care plan selection. The comments can include information used by the case manager outside of the risk factors to determine the best care plan for the patient. In some implementations, a case manager may select a care plan template that does not match the patient risk profile. For example, a case manager may select a low risk care plan template for a moderate risk profile patient if that patient is living with a family member capable of providing round the clock care for the patient. The example of FIG. 20 shows a pop-up warning message to enable the case manager to confirm their selection.

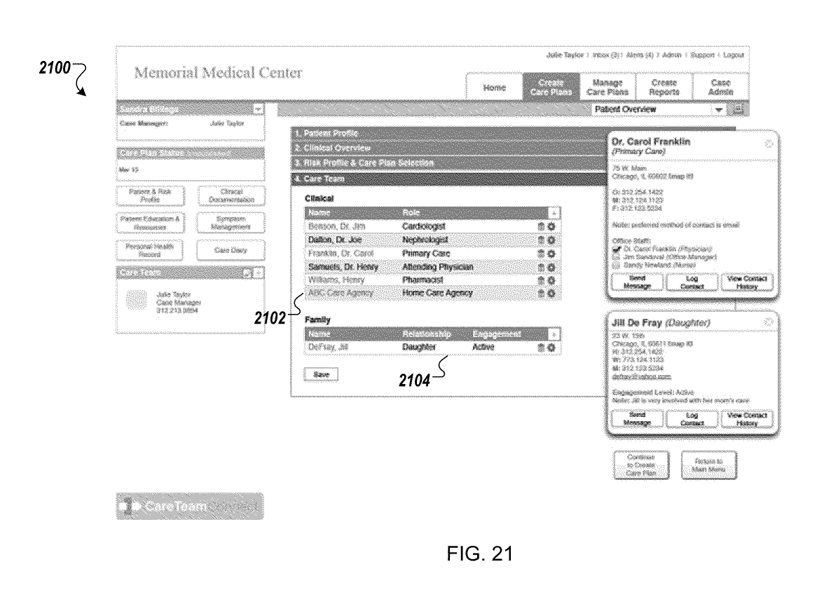

The case manager selects additional care team members (step 218). The case manager can add one or more clinical and/or family members to the care team. In some implementations, as shown in FIG. 21, the case manager selects one or more available members of a clinical care team from a predetermined list. For example, referring to FIG. 1, the hospital computer system 102 can provide the clinical care team list to the care plan computer system 104. Specifically, the physician credentials database 112 of the hospital computer system 102 can provide the names of physicians, home care agencies, and additional clinical support persons or groups in the local community affiliated with the hospital that have preferred patients or rights within the hospital. In some implementations, the hospital computer system 102 provides a list of family members to the care plan computer system 104. For example, the CIS database 110 may include next of kin, responsible family member, and other related information regarding the patient's family. In some implementations, the discharge information database 114 may include information related to the patient's family.

In some implementations, when selecting a physician to include as a care team member, the case manager selects one of a plurality of physicians associated with a particular medical practice. Care plan tasks are assigned to the medical practice and any physician associated with the practice can take action against the task. However, the care team list can show the physician in the practice that is primarily responsible for the patient (e.g., the physician assigned to the patient by the case manager).

In some implementations, the care plan database 118 can include the clinical and family care team lists for the patient. For example, the patient had a previous care plan for post-discharge care related to an earlier hospital stay that included a care team and lists of clinical and family members. In some implementations, the case manager may add additional clinical and/or family members to the list of available care team members. For example, a case manager may want to list additional family members in the event that one family member is not available to support the patient at a particular time. For example, a case manager may want to list additional clinical members if the patient will be receiving their post-discharge care outside of the local community (e.g., they are planning to stay with a family member located outside of the local community).

The case manager determines the care plan details (step 220). The care plan details can include data obtained from a variety of sources such as the hospital computer system 102 (e.g., the CIS database 110, the physician credentials database 112 and the patient discharge information database 114), the care plan computer system 104 (e.g., the care plan database 118), and any additional data entered into the care plan by the case administrator or case manager. The care plan details can pool all the available data for inclusion into a care plan for the patient.

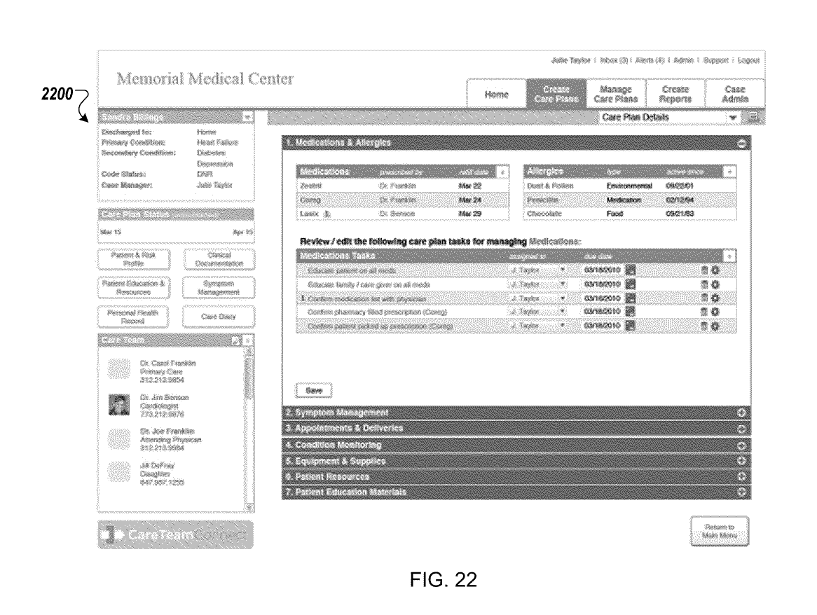

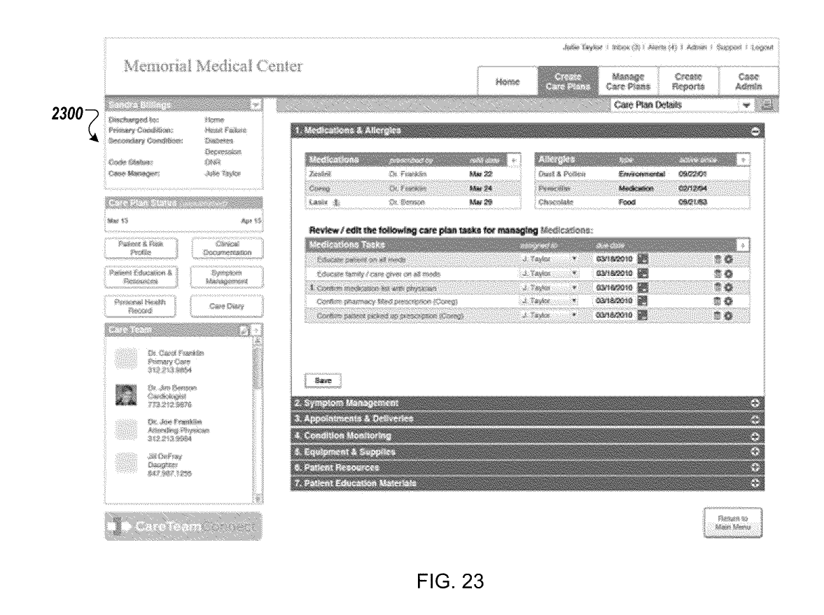

The care plan details can include information on any allergies the patient may have. The care plan details can include determining the prescribed medications to administer to the patient. The care plan details for the prescribed medications can identify the prescribing physicians and refill dates. The care plan tasks related to the prescribed medications can include educating the care team members on all of the medications for the patient. The case manager can assign a care team member to each of the tasks along with a due date to perform the task. In some implementations, the care plan automatically assigns a care team member to a task dependent on their role in the care of the patient (e.g., in a high risk care plan template, the case manager may be automatically assigned the task of refilling a medication for the patient). In some implementations, the care plan can automatically determine a task due date dependent on known data. For example, the refill date of a medication can be determined based on the discharge date of the patient. FIGS. 22 and 23 show example web pages 2200 and 2300 respectively of care plan details for the patient's medications and allergies.

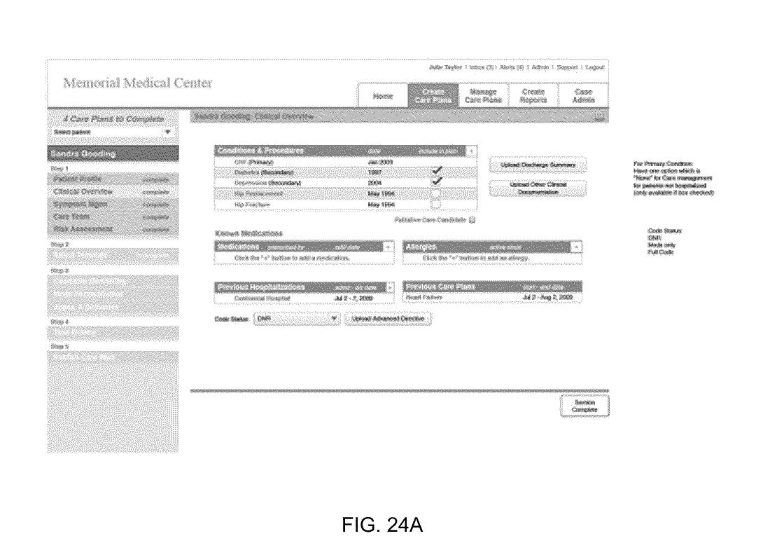

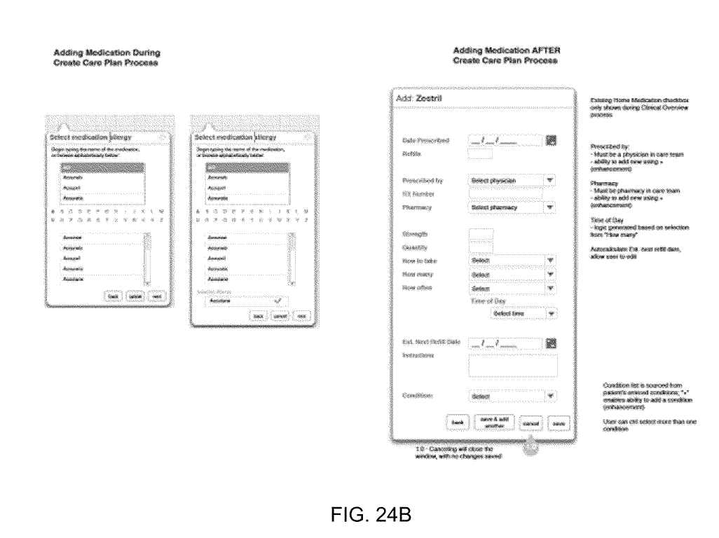

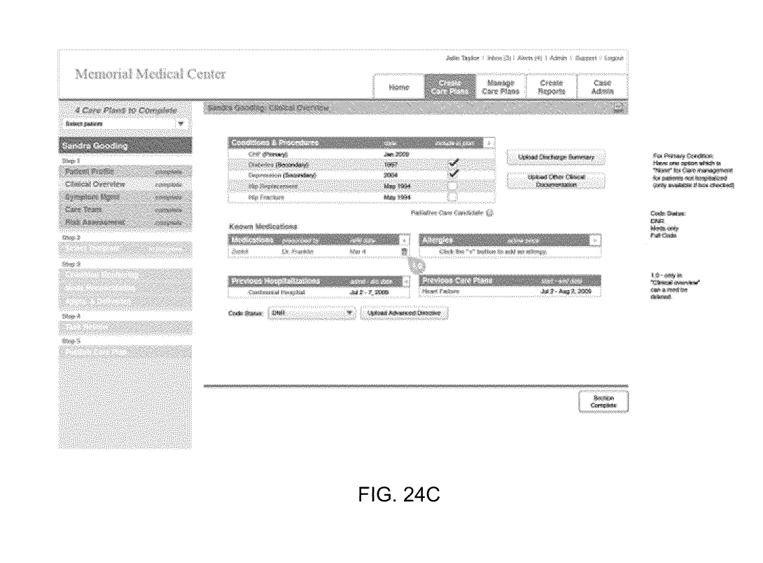

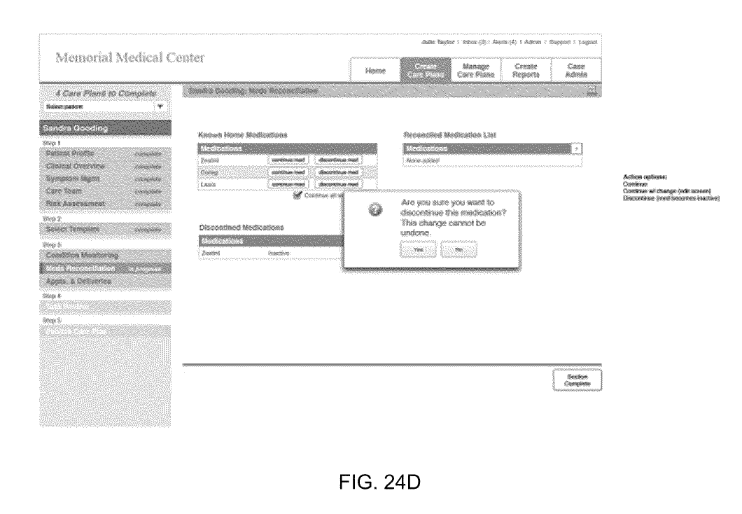

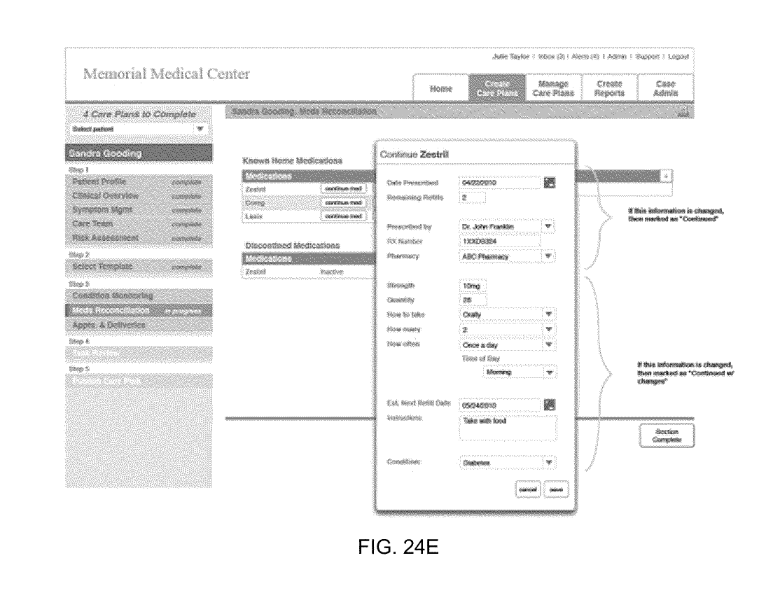

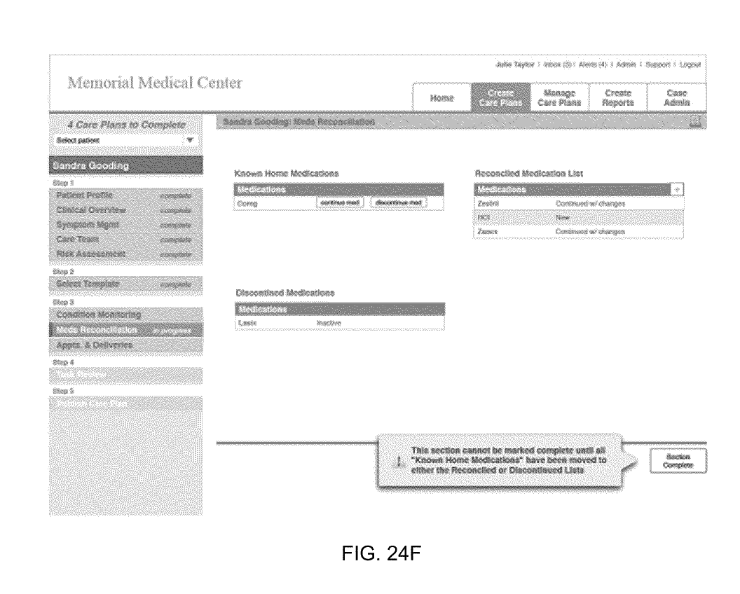

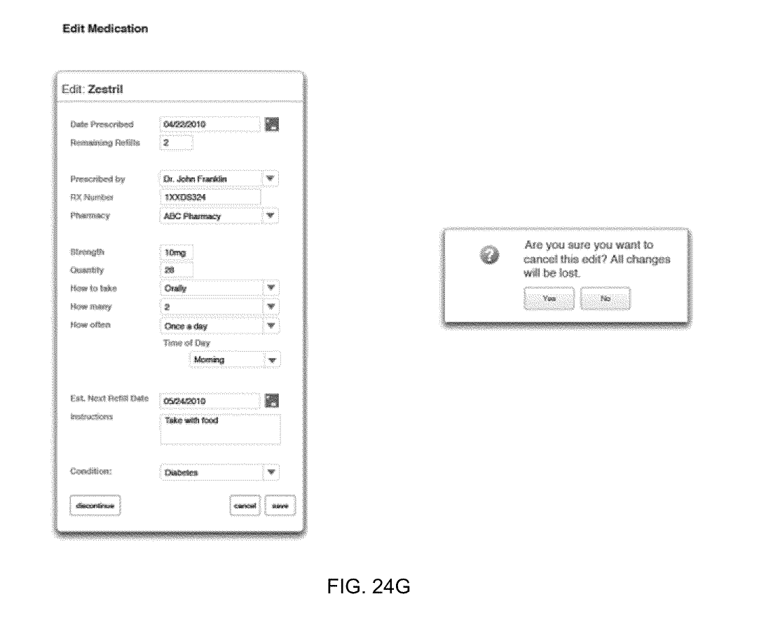

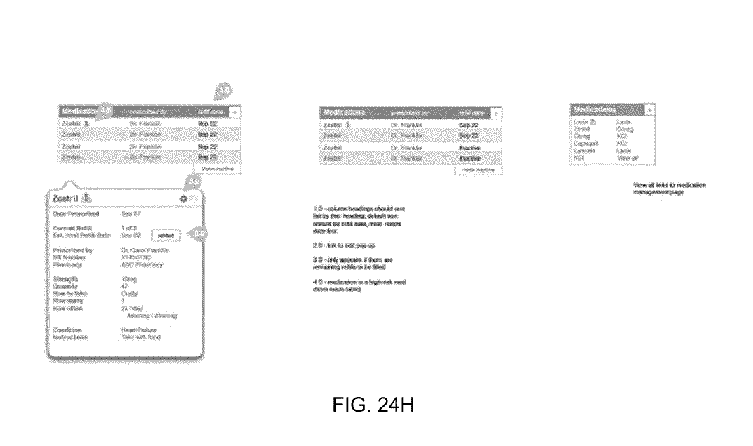

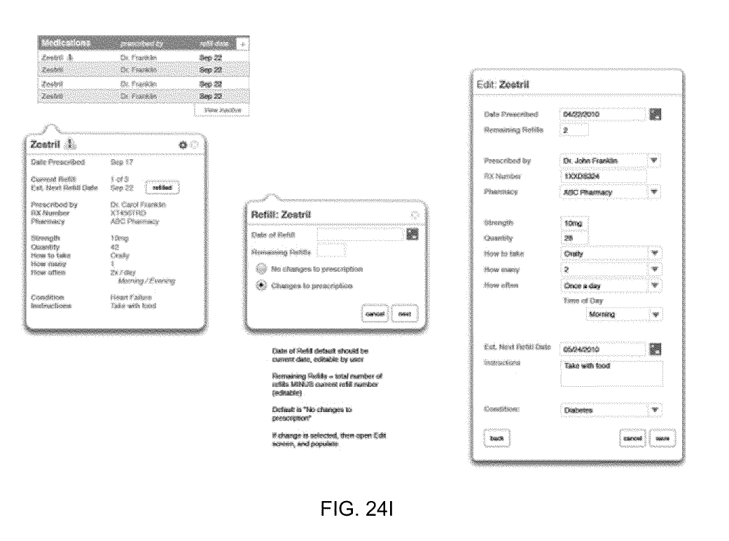

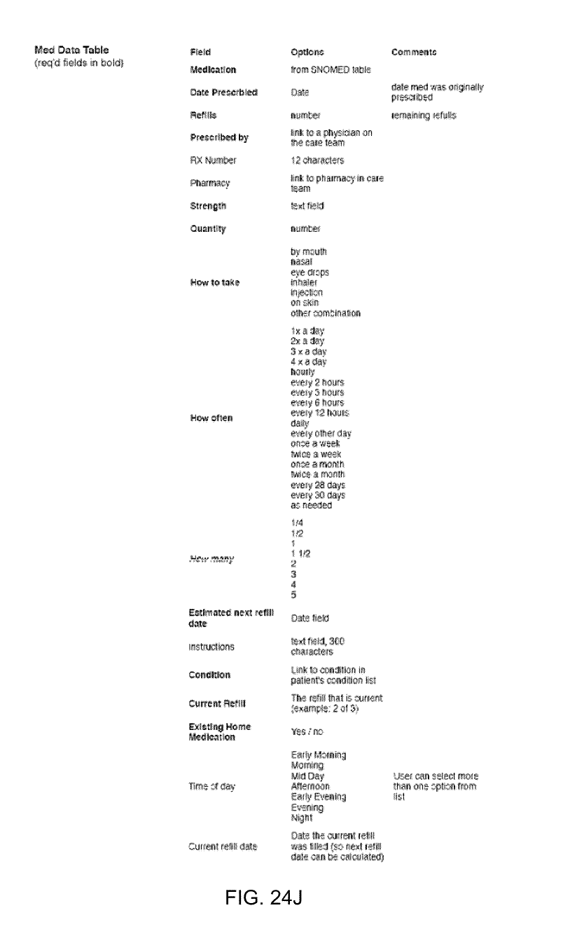

FIGS. 24A-24J are screen shots of example web pages of a medication reconciliation management process for a patient. The case manager can manage the medications prescribed to the patient when discharged. The medication reconciliation management process provides the case manager with the currently prescribed medications for the patient along with any additional medications prescribed at discharge. The medication reconciliation management process provides information related to the prescribed medication that can include but is not limited to the medication name, the date prescribed, the number of remaining refills, the prescription number, the pharmacy, the dosage strength, the quantity, method for taking the medication, how often to take the medication, how dosage amount, time of take to take the medication, the next estimated refill date, and if the medication is an existing home medication. The case manager can use the medication reconciliation management process to determine if a particular medication prescribed for the patient should be continued, discontinued or modified. For example, at discharge a physician can determine that the patient should be administered double their usual dosage of a particular medication that are currently taking for two weeks after discharge. The case manager using the medication reconciliation management process can modify the dosage amount and/or frequency to increase the amount of medication taken by the patient on a daily basis for the two weeks after discharge. In another example, a new medication may be added to the current medications prescribed to the patient. The case manager using the medication reconciliation management process can add the new medication to the medication list for the patient. In another example, a medication may be removed from the patient's medication list if the physician determines that at discharge the patient no longer needs to take the medication (e.g., prior to admittance to the hospital for a cardiac bypass procedure the patient was taking a particular heart medication and not longer needs this medication when discharged).

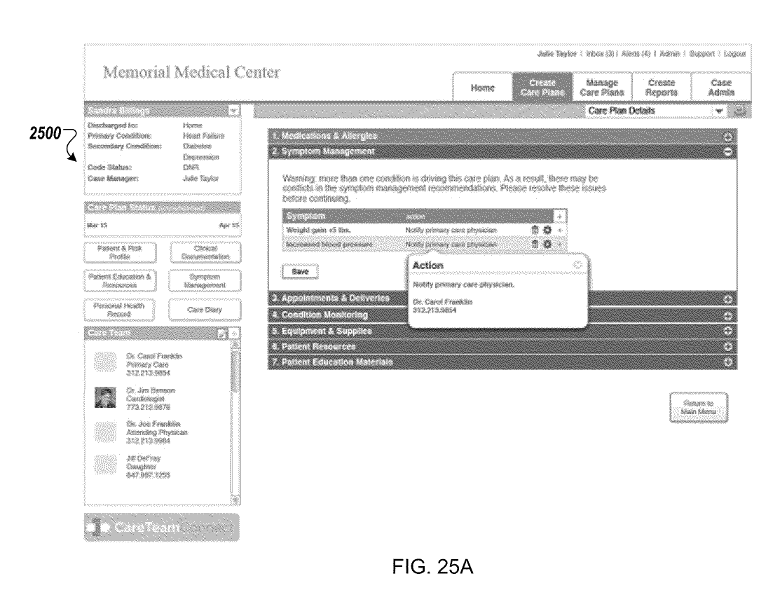

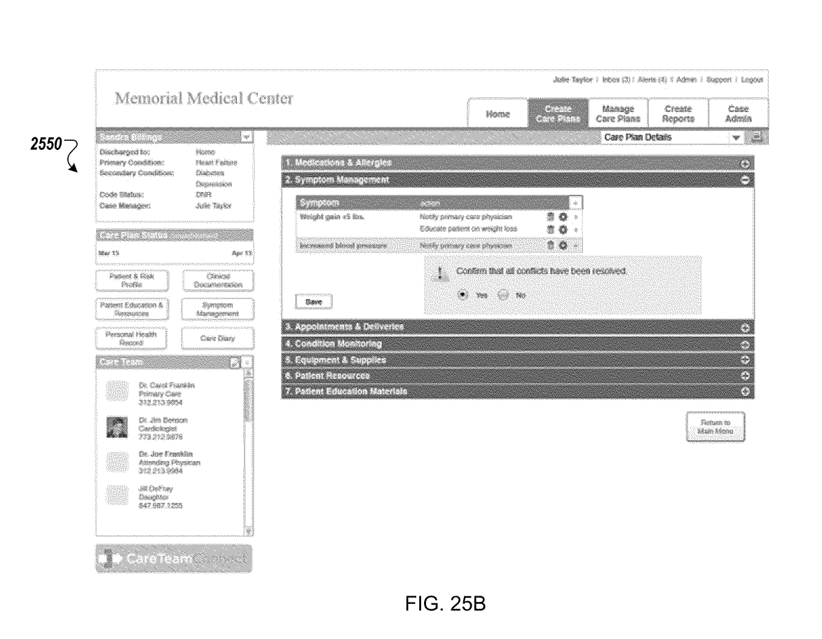

The care plan details can include patient symptom management. The care plan can associate one or more symptoms or conditions to a patient. The care plan can assign to each symptom one or more actions. When the patient exhibits the symptom, the case manager or other care team member should perform the one or more actions. For example, if the patient gains more than five pounds post-discharge, the case manager should notify the primary care physician, as the weight gain could be indicative of a more serious condition. In some cases, a conflict can occur in the symptom management recommendations if more than one condition drives the care plan. In this case, the case manager can resolve the conflict by removing or modifying the conflicting condition. FIGS. 25A and 25B show example web pages 2500 and 2550 respectively of a care plan detail that includes symptom management.

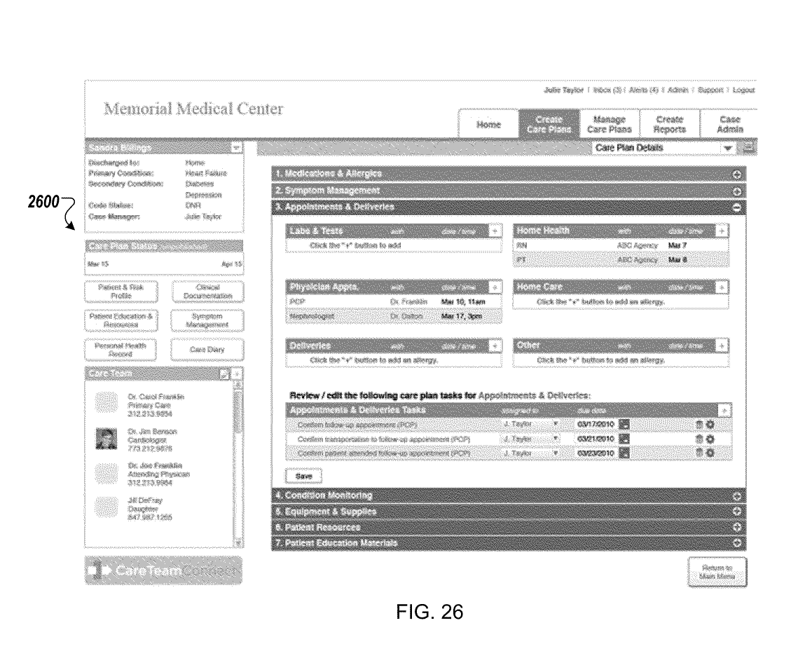

The care plan details can include a schedule of appointments and deliveries for the patient. For example, the care plan can include a schedule of appointments for the patient for lab tests, physician visits, home health care visits (e.g., nurses, physical therapists), home care visits (e.g., meal preparation, personal hygiene assistance), and deliveries (e.g., medical equipment such as portable oxygen tanks). In some implementations, the case manager assigns a care team member and due date for each task associated with an appointment or delivery. For example, the patient may have a follow-up physician appointment scheduled for seven days after discharge. The case manager can assume the task of appointment confirmation the day before the appointment. Additionally, the case manager may assign the task of confirming transportation to the follow-up appointment to a family member. FIG. 26 shows an example web page 2600 of a care plan detail that includes appointments and deliveries for the patient.

The care plan details can include condition monitoring. In some implementations, condition monitoring includes a patient care assessment with one or more care assessment elements. The case manager assigns the care assessment task to a care team member. The care assessment tasks have a start date and a frequency where the frequency indicates how often the care team member should perform the care assessment (e.g., one time per week, “ad hoc” (indicating at any time during the care plan duration), etc.). Care assessment elements are activities the patients may perform for themselves. For example, case assessment elements can include, but are not limited to, eating, dressing, bathing, transfers, mobility, meal preparation, driving, medication management and memory assessment. The ability of the patient to perform one or more of the case assessment elements independently can be based on their risk profile.

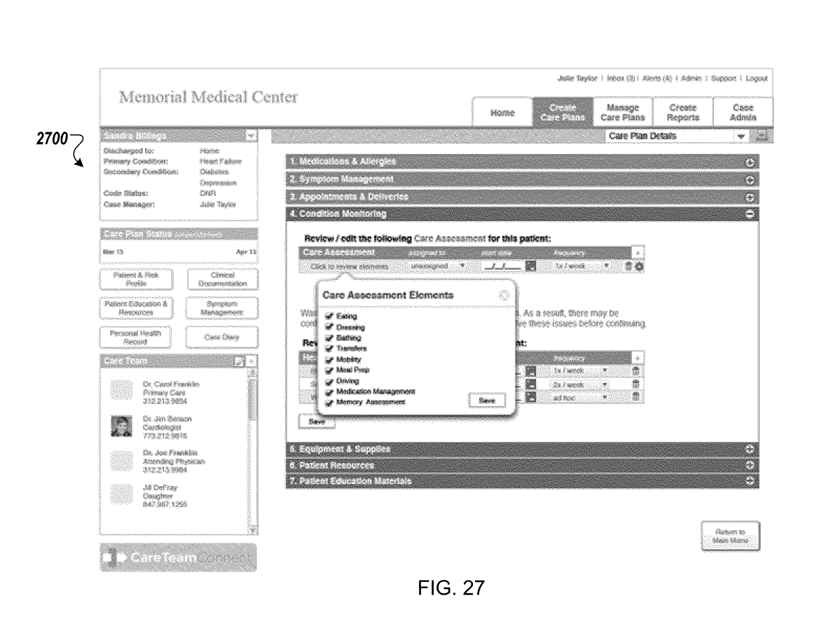

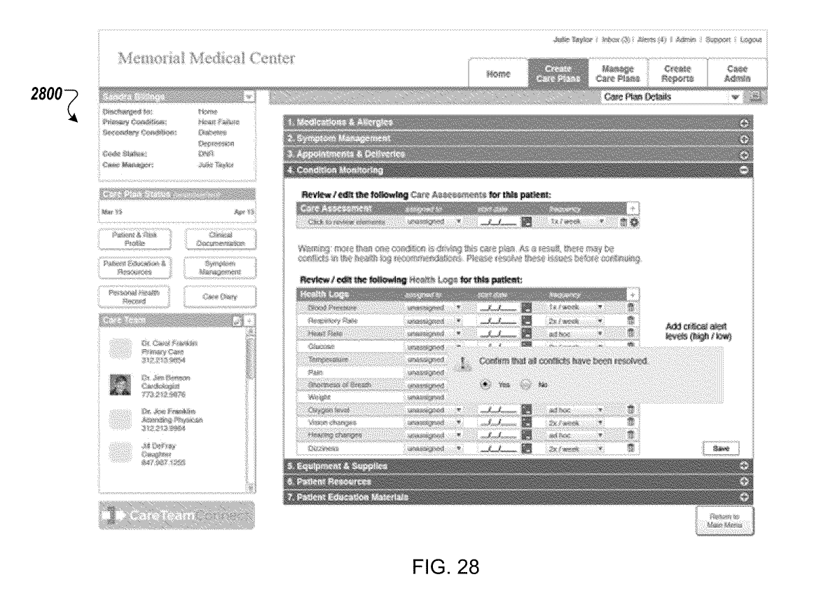

Condition monitoring can include a patient health log. In some implementations, a care team member monitors one or more specific health conditions for a patient. The case manager can assign a health condition assessment to a care team member for monitoring. The care team member can begin monitoring the patient for the specific health condition at a start time assigned by the case manager. Additionally, the care team member can monitor the health condition of the patient at a frequency (e.g., weekly, biweekly, etc.) assigned by the case manager. The care team member enters the result of the health condition assessment on or before the expected date. FIGS. 27 and 28 show example web pages 2700 and 2800, respectively, of a care plan detail that includes condition monitoring. For example, the case manager assigns the task of taking the patient's blood pressure weekly to a visiting nurse on the care team. The nurse enters the results of the blood pressure check into the care plan.

The care plan can send a health alert to care team members if the result of the health condition assessment is unacceptable for the patient. The care plan can send a task alert to the care team if the health condition assessment is not performed when scheduled. Care team member alerts will be described in further detail later in this document.

The care plan details can include equipment and supplies needed by the patient after post-discharge. In some implementations, the case manager determines the equipment and supplies needed by the patient. In some implementations, the case administrator at the hospital determines the equipment and supplies needed by the patient. For example, the hospital computer system 102 can store this information with the patient discharge information in the patient discharge information database 114. The hospital computer system 102 provides the information to the care plan computer system 104. The care plan computer system 104 can include the information in the patient care plan stored in the care plan database 118. In some implementations, if the patient has previously received post-discharge care, the care plan database 118 may include the equipment and supplies needed by the patient for post-discharge care.

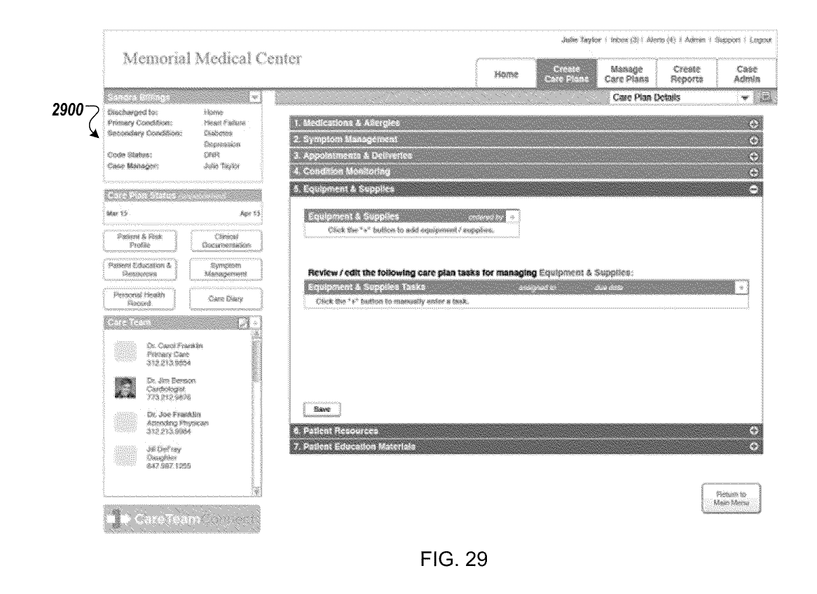

The care plan can include the name of the care team member (e.g., the primary care physician) who ordered the equipment and supplies and the status of the equipment and supply orders (e.g., new, completed). The case manager can create, schedule and assign one or more care plan tasks related to one or more equipment or supply orders. For example, the tasks can include ordering the equipment or supplies and confirming the delivery of the equipment or supplies. FIGS. 29, 30, 31, 32 show example web pages 2900, 3000, 3100, 3200, respectively, of a care plan detail that includes equipment and supply ordering and monitoring.

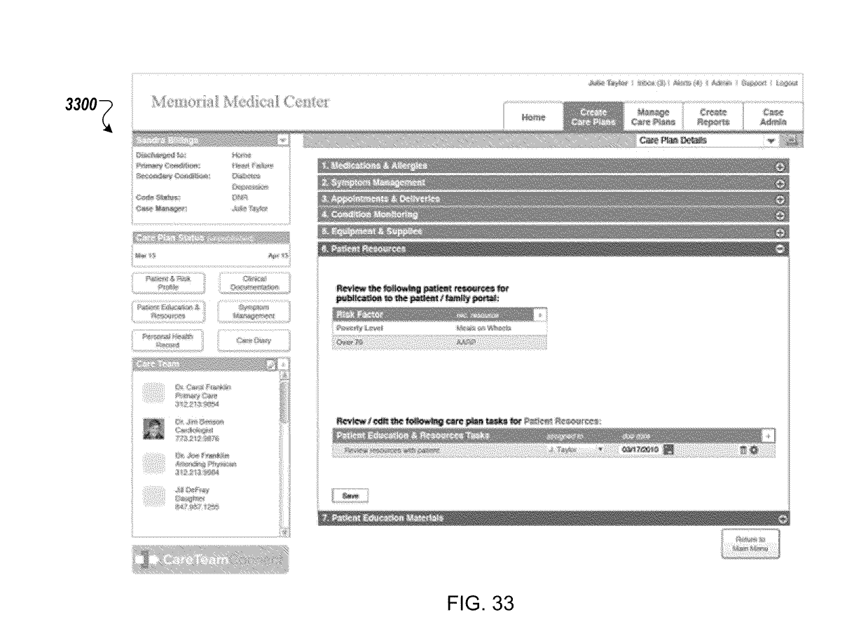

The care plan details can include patient resources. In some implementations, the care plan includes recommended resources for use with managing one or more risk factors for a patient. For example, if the patient is determined to be at or below the poverty level, Meals on Wheels may be a recommended resource for making sure the patient receives at least one meal per day. The case manager can assign and schedule the task of reviewing the one or more recommended patient resources with the patient. FIG. 33 shows an example web page 3300 for patient resources.

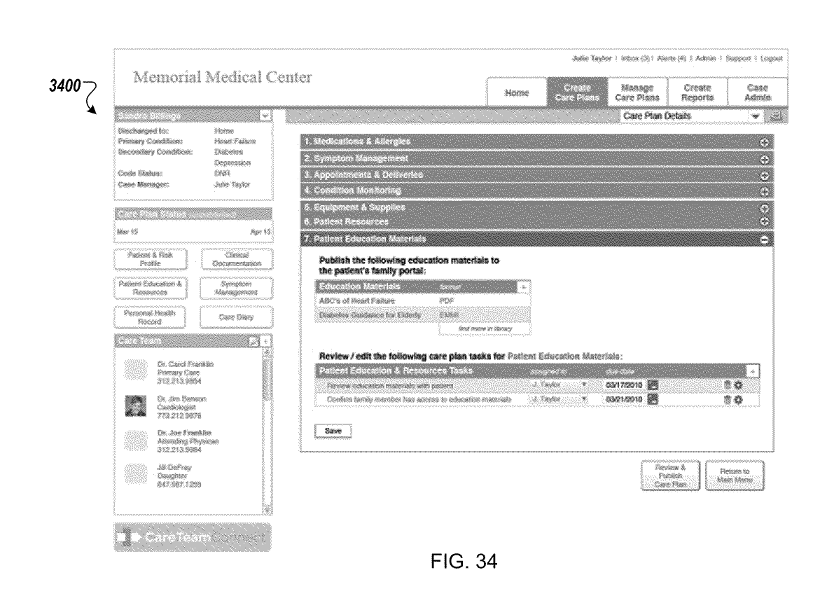

The care plan details can include patient education materials. In some implementations, patient education materials can include printed and electronic articles and other types of documents that provide information to a patient related to their health condition. For example, an eighty-year-old patient with diabetes may benefit from reading an article related to diabetes guidance for the elderly. The case manager can assign and schedule the task of reviewing the patient educational materials with the patient. Additionally, the case manager can assume the task of confirming that the care team family members have access to the educational materials. FIG. 34 shows an example web page 3400 for patient education materials.

The case manager reviews the care plan details (step 222). For example, a web page 3500 as shown in FIG. 35 is displayed to the case manager. It includes a summary of the care plan details for the patient. In addition, it includes a list of care plan tasks. Each task shows the care team member assigned to the task, the completion date for the task and the status of the task (e.g., not started, in progress). The case manager can include one or more notes for each task that provides information related to the completion of the task. For example, the case manager is assigned the task to confirm a medication list for the patient with the patient's physician. The case manager can add a note related to the completion of the task stating they left a message with the physician's office. In this case, the status of the task is listed as “in progress”.

Once the case manager creates and reviews the care plan, the case manager can then publish the care plan (step 224). For example, the case manager activates a publish care plan button on a care plan details web page.

Referring to FIG. 1, the web server 116 stores the published care plan for the patient in care plan database 118. The case manager can later access the patient's care plan by accessing the care team connection portal hosted on the web server 116 using user access device 122. The case manager can enter their login credentials using keyboard 122a in order to access the case manager's home web page on the care team connection portal. The case manager's home web page, displayed on display device 122b, can provide access to the care plans for each patient assigned to the case manager (e.g., the care plan for a patient is retrieved from care plan database 118). The care plan computer system 104 can send the data for the care plan for the patient to the user access device 122 by way of network 106. Display device 122b can display the care plan data to the case manager for review. Additionally, the web server 116 can store the unpublished care plan for the patient in care plan database 118 as the case manager creates the care plan for the patient.

Referring back to FIG. 2, next in the care team connection process the hospital discharges the patient (step 226). When the hospital discharges the patient, care team members included in the care plan for the patient are sent an alert notifying them of the discharge of the patient (step 228). For example, the alert can be in the form of an email message to the care team member, a SMS text message to a mobile device belonging to the care team member, or an alert to a pager or beeper belonging to a care team member.

Once alerted of the discharge of the patient, the care team connection process can communicate the required actions included in the care plan to the care team (step 230). In some implementations, this communication is within twenty-four hours of the patient's discharge. Each care team member assigned to a care plan for the patient can access the care plan once the case manager publishes the care plan. Referring to FIG. 1, each care team member can login to the care team connection portal hosted on the web server 116 using a user access device (e.g., user access device 122, 124, 126). In the case where a care team member is assigned to more than one patient, the care team member will be presented with a home web page that includes an inbox to combine information and communications for all patients into a centralized area. Once logged into the care team portal, the care team member can view a list of tasks for the patient they are responsible for monitoring. In some implementations, the task list can include a due date and status. Additionally, the care team member can include one or more notes related to the completion of the task. The case manager is an example of a care team member assigned to a plurality of patients.

A care team can include one or more members where each member has particular access rights to the patient's care plan. For example, the access rights can depend on the role of the care team member in the patient's care. The case administrator, the case manager and a location administrator (e.g., a designated hospital employee) can have full access rights to the patient's care plan, including care plan creation, management and report creation. Clinical care team members (e.g., physicians, visiting nurses, social workers, etc.), family care team members, and the patient can have limited access rights to the patient's care plan. For example, the clinical care team members, the family care team members and the patient are not allowed to create or manage the patient's care plan.

In some implementations, once the care plan is published and the patient is discharged from the hospital, the one or more physicians who are care team members for the patient can receive a list of tasks for the patient through a secure communication channel between the care plan computer system and the physician's computer system. For example, referring to FIG. 1, the care plan computer system 104 can establish a secure communication channel to the physician's computer system by way of network 106.

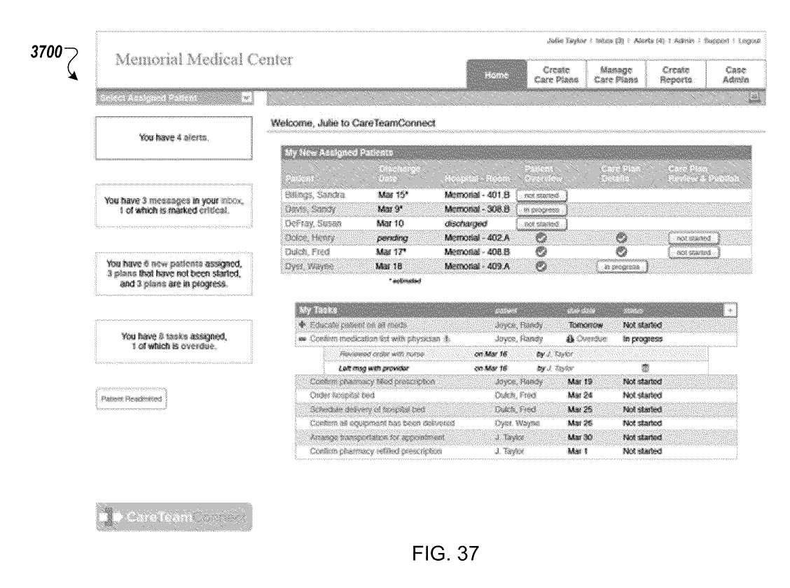

For example, once logged into the care team connection portal, the case manager is presented with a home web page 3700 as shown in FIG. 37. The home web page for the case manager can include a list of patients assigned to the case manager and their current location (e.g., hospital name and room number, discharged). The home web page for the case manager includes the status of the patient's care plan (e.g., if the case manager has completed the patient overview, care plan details, and care plan review and publishing for the patient's care plan). The home web page for the case manager also includes a list of tasks for the case manager for all of their assigned patients. The task list can indicate the due date for each task, the status of each task and the patient associated with the task.

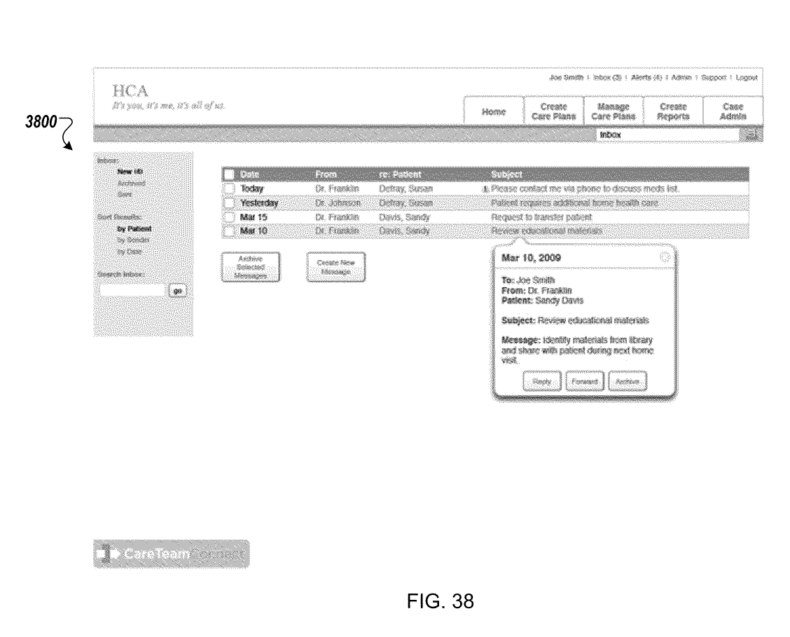

For example, once logged into the care team connection portal, the case manager is additionally presented with a web page 3800 for an inbox as shown in FIG. 38. The inbox can consolidate communications to the case manager for all patients assigned to the case manager into one centralized area.

Similarly, care team members who are also assigned to more than one patient can login to the care team connection portal and view a similar home web pages and inbox as that of the case manager example shown in FIGS. 37 and 38.

Referring back to FIG. 2, next in the care team connection process patient activities are tracked (step 232). For example, the care plan computer system 104, specifically the care plan management application, monitors and tracks the execution and completion of the tasks associated with the patient's care plan stored in the care plan database 118. Care plan members login to the care team connection portal and regularly review and update the status of their assigned tasks. The care plan management application monitors the status and outcome of each scheduled task included in the care plan for the patient. The care plan management application can identify an outstanding task whose due date is imminent or has passed and can generate reminders for these tasks. The care plan management application can generate status alerts if the outcome of a particular completed task needs attention. The care team members receive the reminders and status alerts (step 234).

For example, the care plan management application can generate an alert if the completion of a task is imminently due or if the due date has passed. The care plan management application can generate a status alert if the outcome of a care assessment was unsatisfactory. Additionally, the care plan management application can generate an alert if the patient is readmitted to the hospital.

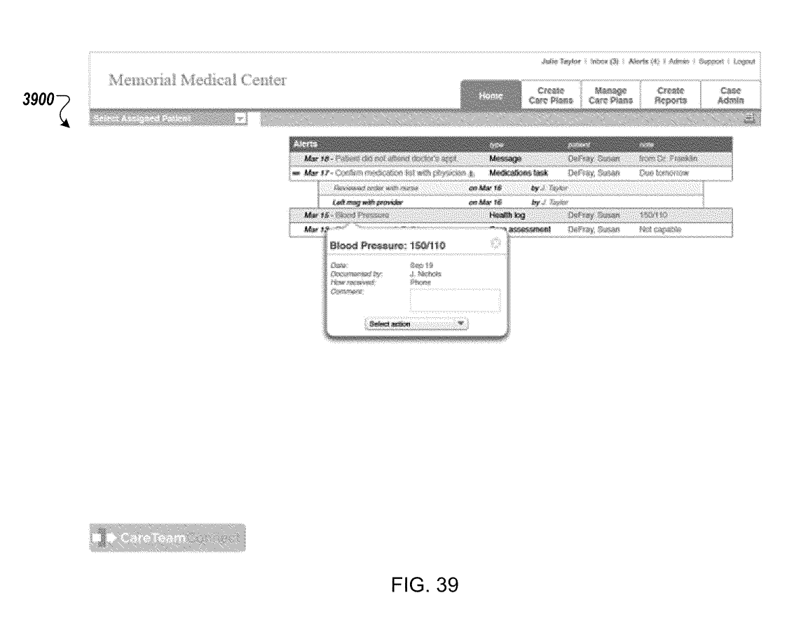

For example, the case manager can login to the care team connection portal and view their home web page. Included in their home web page are reminders and status alerts regarding specific tasks for each patient assigned to the case manager. FIG. 39 shows a home web page 3900 that includes a list of reminders and status alerts associated with the patients assigned to the case manager. An alert can indicate the completion of a task is past due. For example, a patient was scheduled for bathing on a specific date and the task was not performed. A note can be associated with the alert indicating why the task was not performed (e.g., the patient was not capable of being bathed at that particular time). In some implementations, the case manager can reschedule the task for a later date (e.g., schedule bathing for next week). In another example, the refilling of a prescription for a patient is overdue. Additional information associated with the alert can allow the case manager to reassign the task to another care team member who may be able to complete the task (e.g., the case manager can assign the task of refilling the patient's prescription to a family member). A reminder can indicate the completion of a task is imminent. For example, a physician needs to confirm the patient's medication list by the next day. A status alert can indicate a specific medical status of the patient needs attention. For example, the blood pressure of the patient is too high. In some implementations, the case manager can select an action for the task that generated the alert. For example, the case manager can reassign the task, put the task on hold, delete the task, or change the date for task completion to a date sometime in the future.

In some implementations, the generation of an alert for a patient is based on the patient's risk profile. In general, the higher the risk profile of the patient the more likely it is that the patient will be readmitted to the hospital within thirty days of discharge. For example, a high risk profile patient has not scheduled or attended a recommended seven day follow-up visit after discharge. The care plan management application can generate and send an alert informing the care team of the neglected follow-up visit. For example, if none of the scheduled tasks for a low risk profile patient are performed, that patient may also be at high risk for readmission. Therefore, the care plan management application can generate and send an alert informing the care team of the lack of task completions in order for the care team to correct the situation.

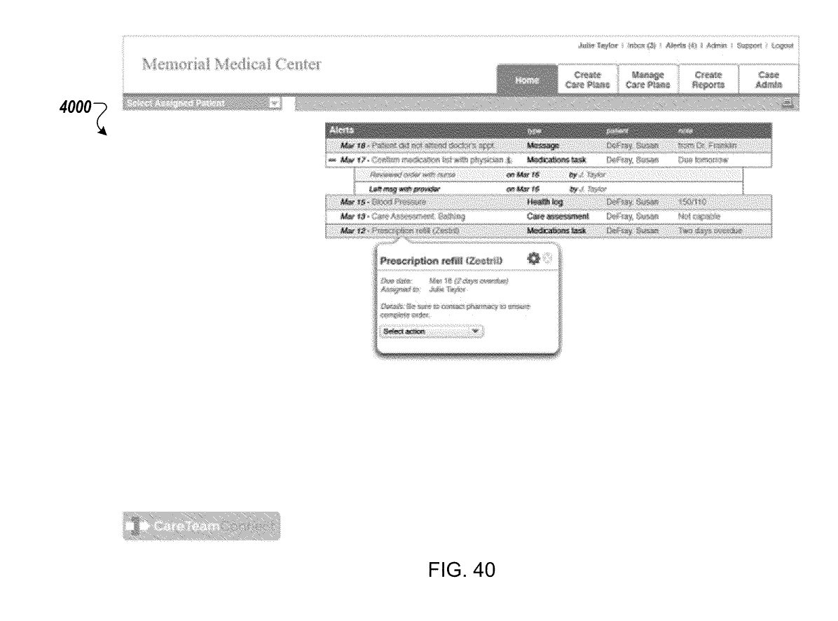

FIGS. 39 and 40 show example web pages 3900 and 4000 respectively that list reminders and alerts for a case manager. Similarly, additional care team members can receive and view reminders and alerts. In some implementations, the case manager will be the only care team member allowed to select an action for tasks that generate reminders and alerts.

In some implementations, referring to FIG. 1, a case manager remotely accesses the care plan computer system 104, by way of network 106 using user access device 122, to review a patient's care plan summary. The case manager can access the care team connection portal hosted on the web server 116. The case manager can enter their login credentials using keyboard 122a in order to retrieve the care plan summary for a particular patient from the care plan database 118 included in the care plan computer system 104. The care plan computer system 104 can send the data for the care plan summary for the patient to the user access device 122 by way of network 106. Display device 122b can display the care plan summary data to the case manager for review.

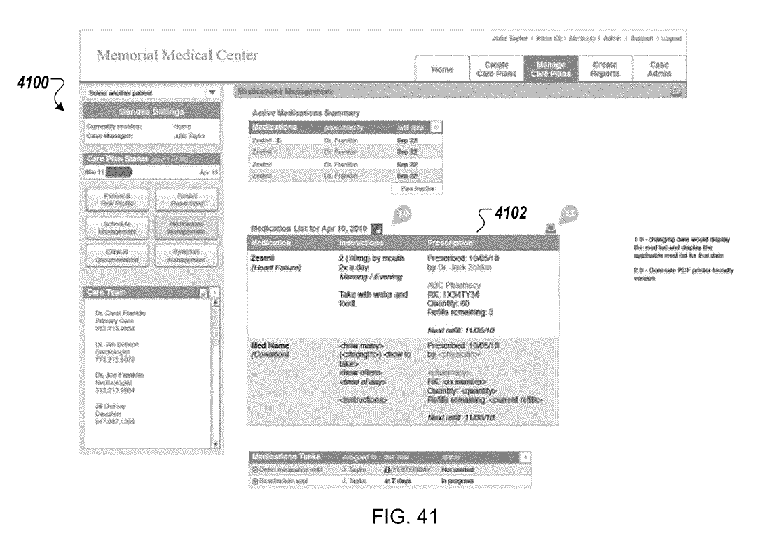

FIG. 41 is a screen shot of an example web page 4100 that includes a medication list 4102 for a patient. The medication list 4102 provides care team members with a list of the patient's medications, instructions for taking the medication and prescription information for each medication.

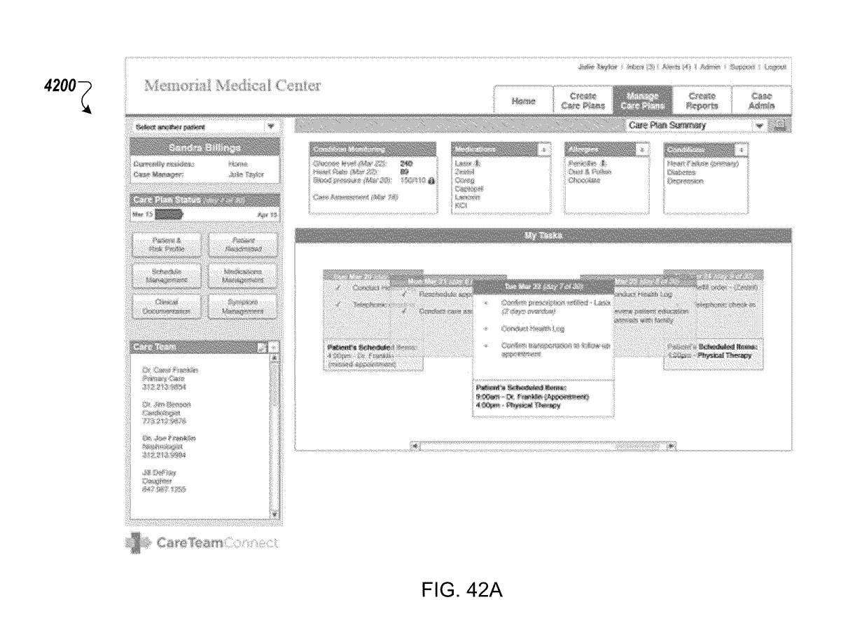

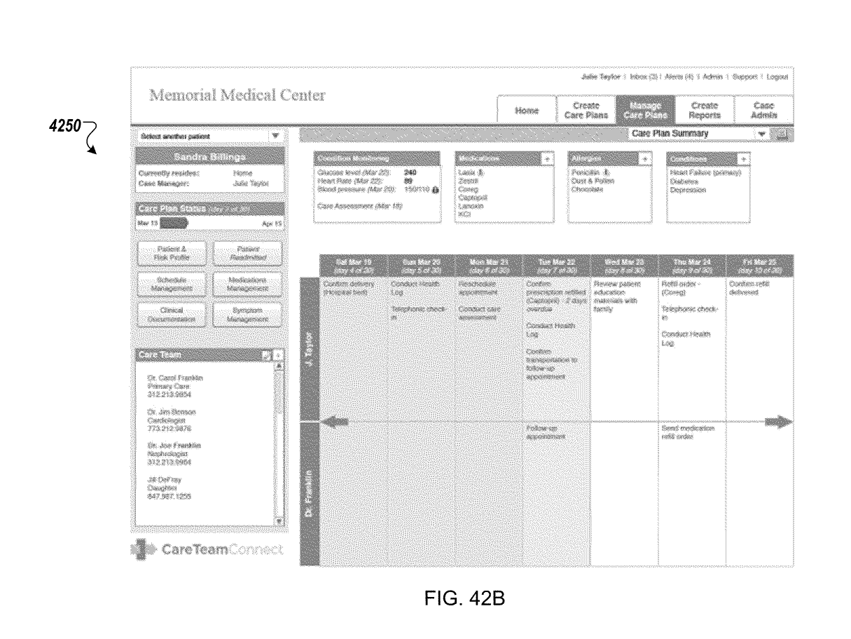

FIGS. 42A and 42B show example web pages 4200 and 4250 respectively that show a care plan summary for a specific patient assigned to the case manager. The web page 4200 provides each care team member a per-patient view of their tasks including a summary of critical information such as alerts, health logs, medications, and allergies. The care plan summary can include a health log indicating the type of tests administered to the patient, the date the test was administered, and the test results. The care plan summary can include a medications list and a list of allergies. Items included in each list may have an associated alert indication if any of the items require attention. A list of the case manager's tasks for the patient can also be included in the care plan summary. The list can be displayed to the case manager on a day-by-day basis indicating the tasks, their completion status and any notes associated with the task. Alternatively, the case manager's tasks along with the tasks assigned to other care team members for the patient can be displayed to the case manager on a day-by-day basis. Additionally, the care plan summary can include an indication of the current day of the care plan related to the total number of days for the care plan (e.g., day 10 of 30).

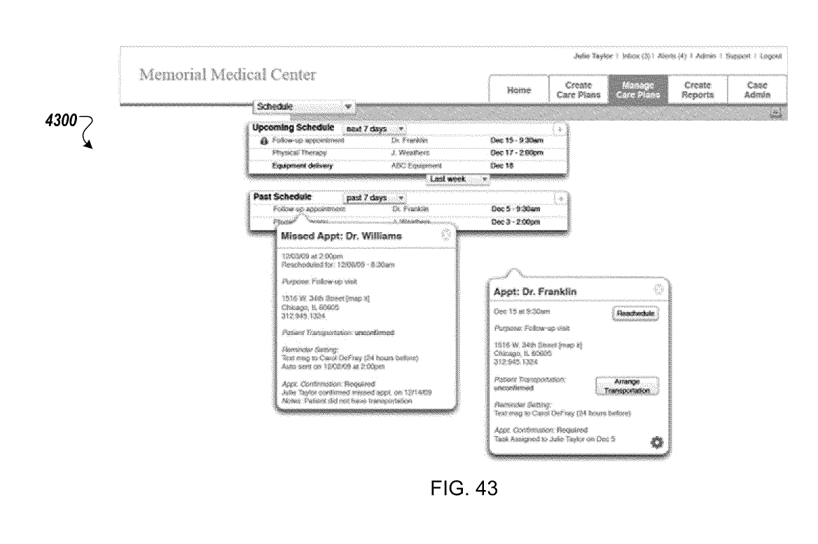

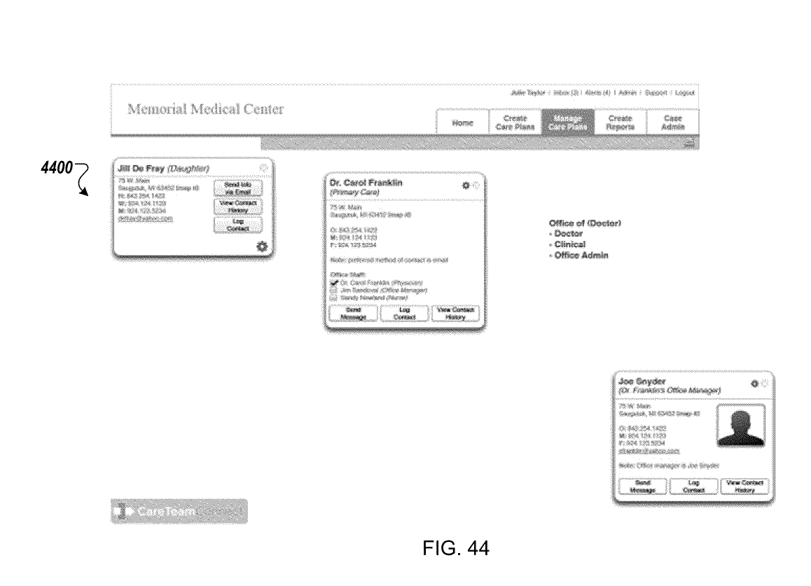

The case manager can manage a patient's care plan at any time during the duration of the care plan from creation through execution. The case manager can access detailed information associated with each task included in the care plan. The detailed information can include notes and further needed actions related to the completion of the task. FIG. 43 shows an example web page 4300 that includes detailed information associated with a task. The case manager can access available information for each care team member assigned to a case manager's patient. The case manager can use the information to contact the care team member. FIG. 44 shows an example web page 4400 that includes information for one or more care team members.

The care plan ends (step 236). For example, the care plan can end if a patient is readmitted to the hospital before the duration of the care plan expires. In another example, the care plan can end if the duration of the care plan expires (e.g., thirty days after the hospital discharge of the patient). If the care team connection portal is not deactivated in step 238, the care team family members can continue to use the care team connection portal to manage the patient's care (step 240). FIG. 45 shows an example of an entry web page 4500 for the family portal. The family portal can include, but is not limited to, a patient care diary, a patient health record, a patient schedule, and a resource center. For example, the patient care diary can provide a log of patient care assessments and physician visits. The patient health record can provide a log of the results of care assessments. The patient schedule can provide a schedule of the patient's physician appointments, physical therapy appoints, home health care visits, and other appointments and/or visits scheduled for the patient. The resource center can include articles and other important information the care team as well as the patient can use for the management of the care for the patient (e.g., an article on diabetes in the elderly for an eighty-year-old patient).

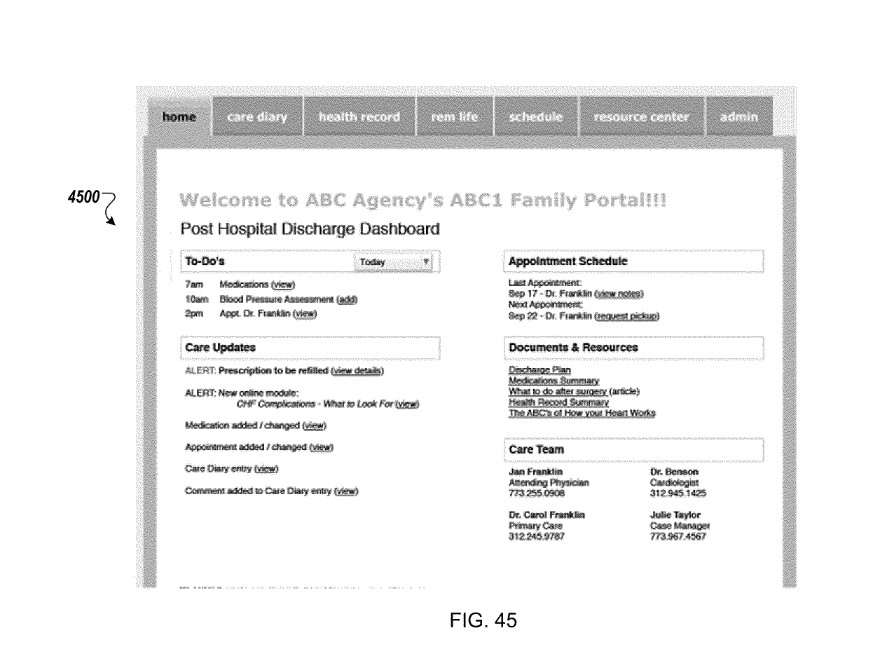

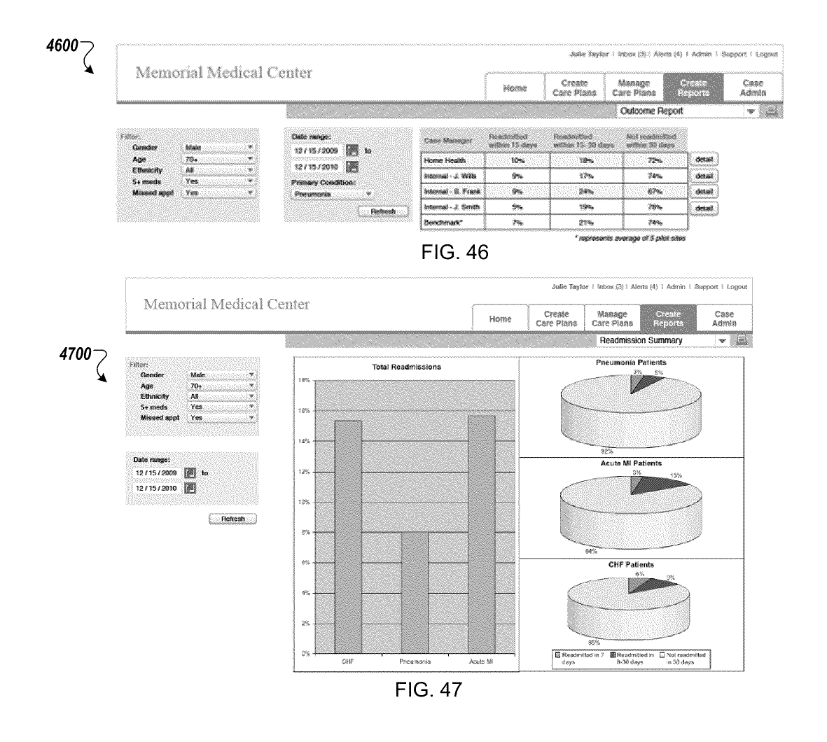

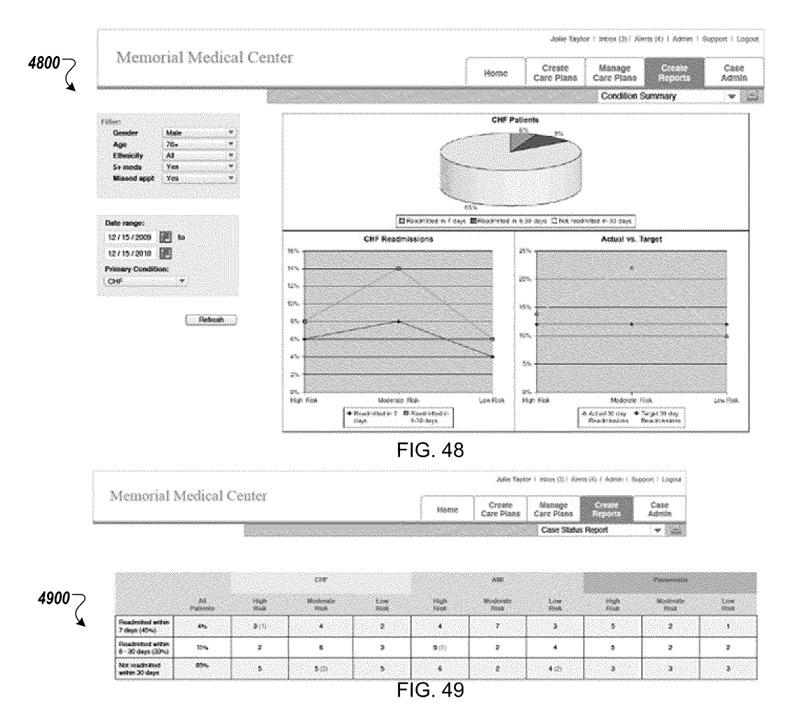

Referring back to FIG. 2, next in the care team connection process, patient outcomes are reviewed (step 242). Outcomes can be reviewed to track readmissions, evaluate patient satisfaction, and to quantify the quality of care provided the patient. For example, referring to FIG. 1, the care plan computer system 104 can produce one or more reports and/or summaries based on data included in patient care plans stored in the care plan database 118. The reports and summaries can compile readmission data for patients based on one or more factors. Examples of reports and summaries can include, but are not limited to, an outcome report, a readmission summary, a condition summary and a case status report. An outcome report can show patient readmission data by case manager assignment. FIG. 46 shows an example web page 4600 that includes an outcome report for patient readmissions. A readmission summary can show patient readmission data by diagnosed medical condition (e.g., congestive heart failure, pneumonia, and acute myocardial infarction). FIG. 47 shows an example web page 4700 that includes a readmission summary for patient readmissions. A condition summary can show patient readmission data for a specific diagnosed medical condition based on the patient risk profile (e.g., low risk, moderate risk, high risk). FIG. 48 shows an example web page 4800 that includes a condition summary for patient readmissions. A case status report can show patient readmission data by diagnosed medical condition and the patient risk factor. FIG. 49 shows an example web page 4900 that includes a case status report for patient readmissions.

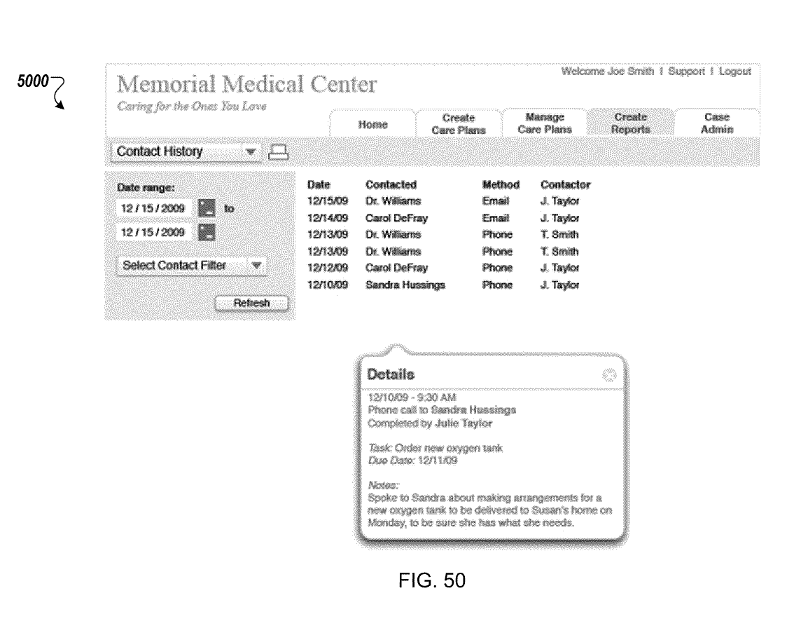

In some implementations, a contact history report can list contacts made by care team members related to a patient's care plan. Additionally, details related to the contact can be provided. FIG. 50 shows an example web page 5000 that shows a contact history report.

In some implementations, when a patient is readmitted to the hospital, the care plan computer system 104 can provide the hospital computer system 102 with an updated list of the patient's current medications. The patient medication list can be included in the patient's care plan stored in the care plan database 118.

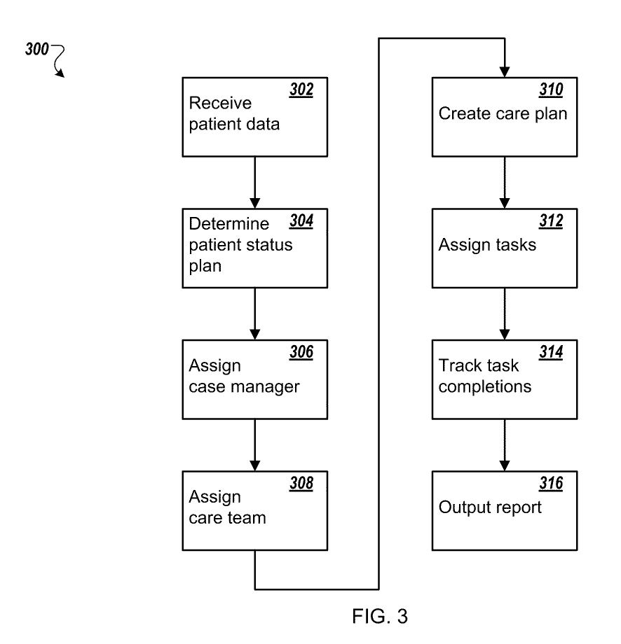

Referring now to FIG. 3, a flowchart illustrates example steps 300 that can be executed in accordance with implementations of the present disclosure relating to a patient care plan. The steps 300 are described with reference to FIG. 1. In step 302, patient data is received. The patient data can include patient demographic data received from the hospital computer system 102. The patient status plan is determined in step 304. The patient status plan can include patient discharge data received from the hospital computer system 102. In step 306, a case manager is assigned. The case administrator can assign a case manager using one or more criteria. The care team is assigned in step 308. The case manager can assign the care team based on geographic location and the needs of the patient. A care plan is created in step 310. The case manager can create a care plan for a patient assigned to the case manager. The tasks included in the care plan are assigned to care team members in step 312. The case manager can assign one or more tasks to each care team member. The completion of one or more tasks is tracked in step 314. The care plan management application can monitor the status of tasks included in the care plan and determine if the tasks have been successfully completed. A report is output in step 316. For example, the report can present data related to the readmission rates for patients having care plans.

FIG. 4 is a screen shot of an example web page 400 for a hospital that includes a login credentials window 402.

FIG. 5 is a screen shot of an example web page 500 that includes a list of patients 502 in a hospital ready for discharge.

FIG. 6 is a screen shot of an example web page 600 that includes a pop-up window 602 for assigning a case manager to one or more patients.

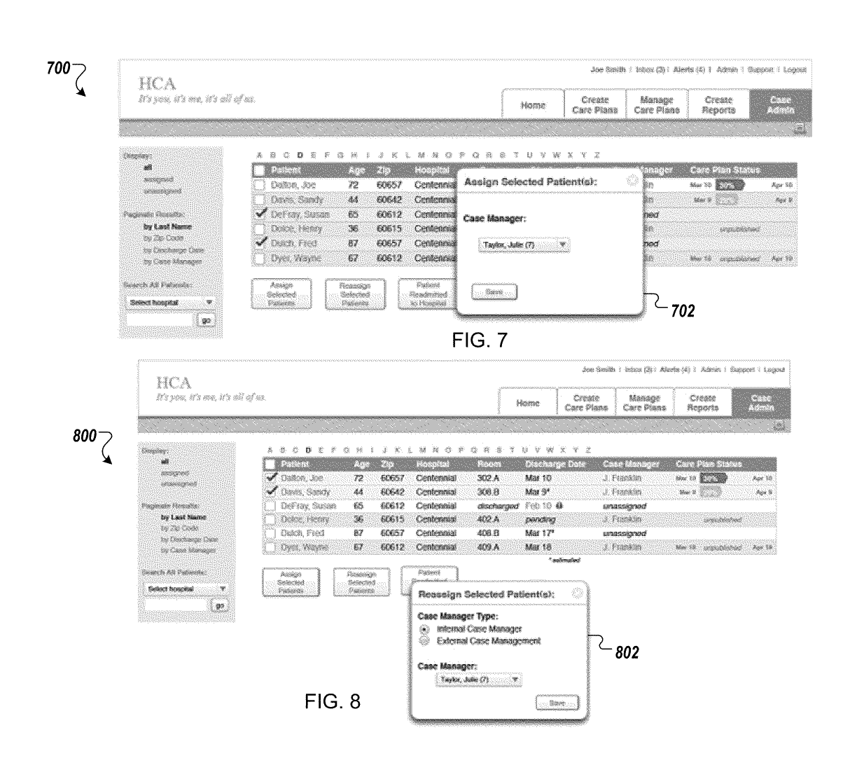

FIG. 7 is a screen shot of an example web page 700 that includes an alternate pop-up window 702 for assigning a case manager to one or more patients.

FIG. 8 is a screen shot of an example web page 800 that includes a pop-up window 802 for reassigning the case manager of one or more patients.

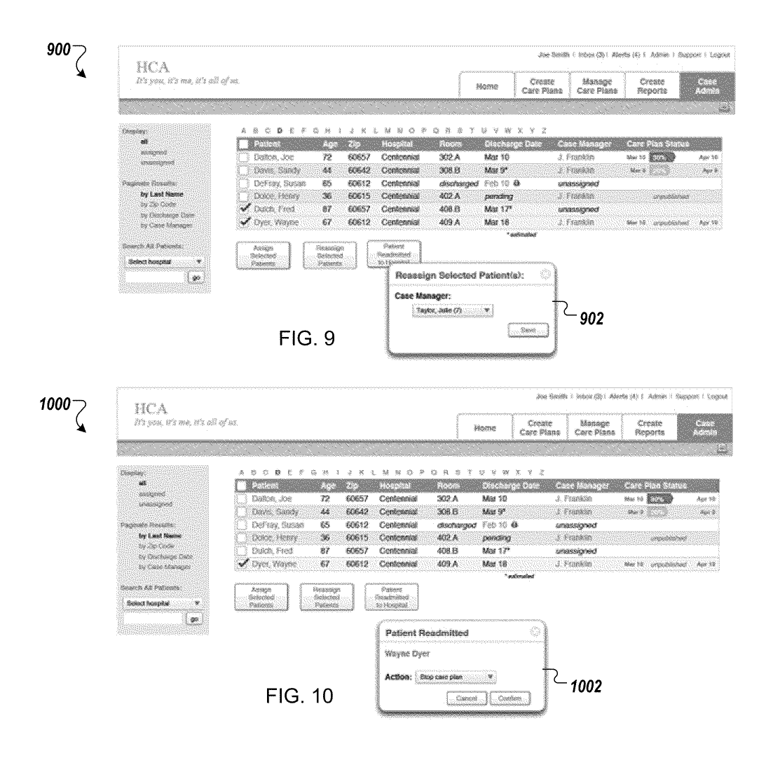

FIG. 9 is a screen shot of an example web page 900 that includes an alternate pop-up window 902 for reassigning the case manager of one or more patients.

FIG. 10 is a screen shot of an example web page 1000 that includes a pop-up window 1002 for a readmitted patient.

FIG. 11 is a screen shot of an example web page 1100 that includes a list of patients for a case manager.

FIG. 12 is a screen shot of an example web page 1200 that includes a patient profile.

FIG. 13 is a screen shot of an example web page 1300 that includes a clinical overview for a patient.

FIG. 14 is a screen shot of an example web page 1400 of a clinical overview for a patient that includes an add new condition drop-down menu 1402.

FIG. 15 is a screen shot of an updated example web page 1500 of a clinical overview for a patient that includes an additional patient condition 1502.

FIG. 16 is a screen shot of an example web page 1600 of a clinical overview for a patient that includes an add medication drop-down menu 1602.

FIG. 17 is a screen shot of an example web page 1700 of a clinical overview for a patient that includes a hospital details drop-down menu 1702.

FIG. 18 is a screen shot of an example web page 1800 of a risk profile and care plan selection for a patient.

FIG. 19 is a screen shot of an example web page 1900 for patient risk factor data entry.

FIG. 20 is a screen shot of an example web page 2000 for patient risk factor data entry that includes a pop-up warning message 2002.

FIG. 21 is a screen shot of an example web page 2100 for care team member selection that includes a clinical member list 2102 and a family member list 2104.

FIG. 22 is a screen shot of an example web page 2200 of care plan details for patient medications and allergies.

FIG. 23 is a screen shot of an alternate example web page 2300 of care plan details for patient medications and allergies.

FIGS. 24A-24J are screen shots of example web pages of a medication reconciliation management process for a patient.

FIG. 25A is a screen shot of an example web page 2500 of a care plan detail for patient symptom management.

FIG. 25B is a screen shot of an alternate example web page 2550 of a care plan detail for patient symptom management.

FIG. 26 is a screen shot of an example web page 2600 of a care plan detail that includes appointments and deliveries for the patient.

FIG. 27 is a screen shot of an example web page 2700 of a care plan detail that includes condition monitoring.

FIG. 28 is a screen shot of an alternate example web page 2800 of a care plan detail that includes condition monitoring.

FIG. 29 is a screen shot of an example web page 2900 of a care plan detail that includes equipment and supply management.

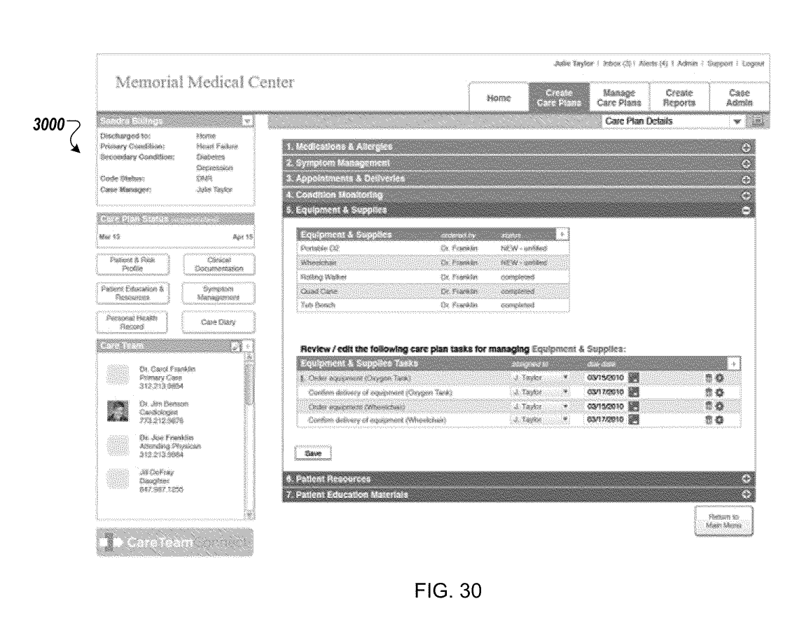

FIG. 30 is a screen shot of an example web page 3000 of a care plan detail that includes equipment and supply ordering and monitoring.

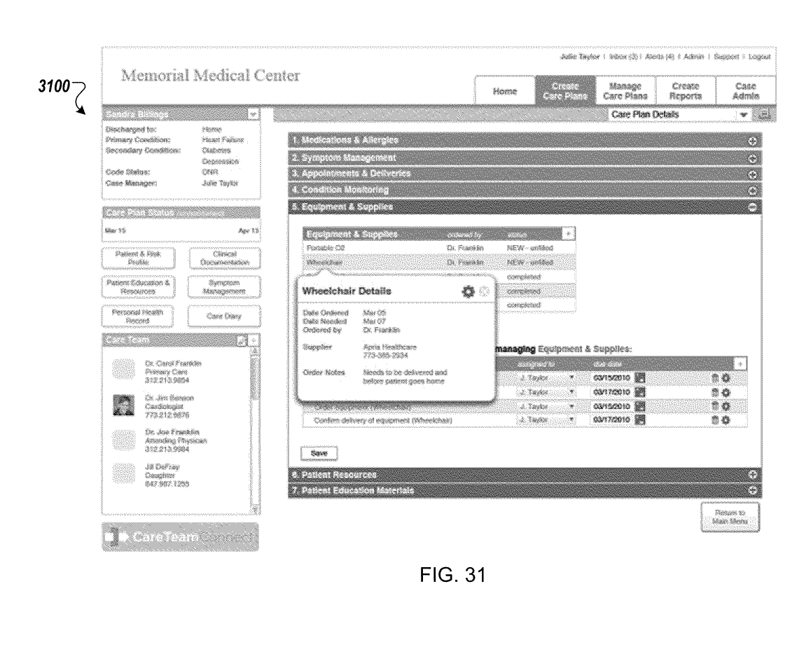

FIG. 31 is a screen shot of an example web page 3100 of a care plan detail that includes equipment and supply details.

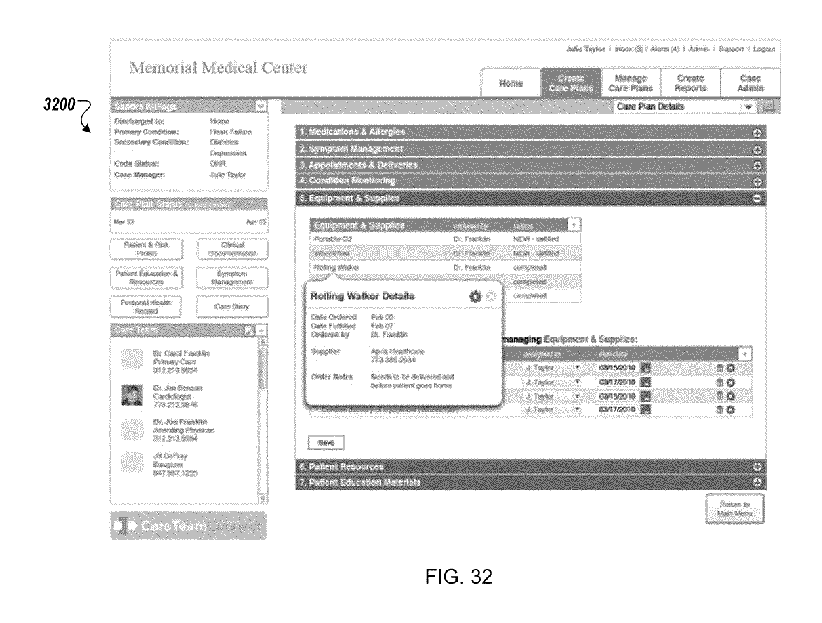

FIG. 32 is a screen shot of an alternate example web page 3200 of a care plan detail that includes equipment and supply details.

FIG. 33 is a screen shot of an example an example web page 3300 for patient resources.

FIG. 34 is a screen shot of an example web page 3400 for patient education materials.

FIG. 35 is a screen shot of an example web page 3500 for review of a care plan.

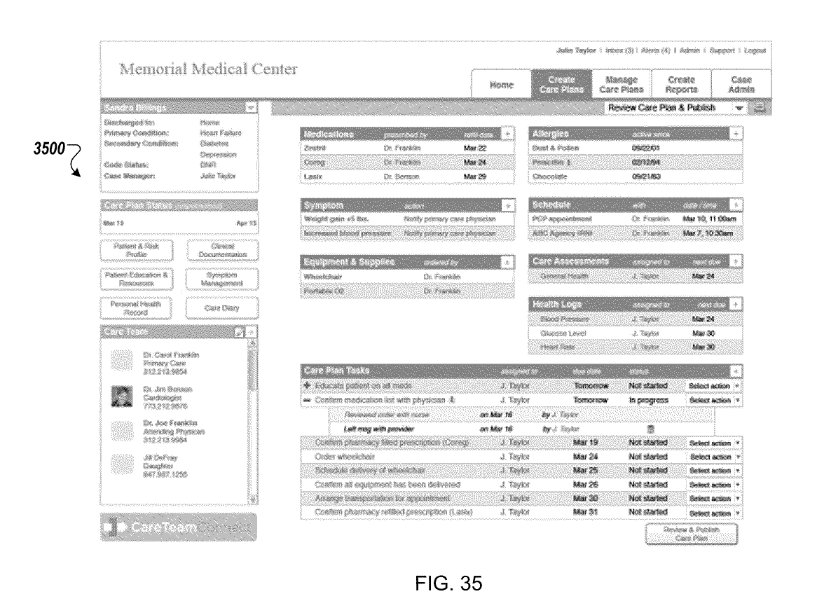

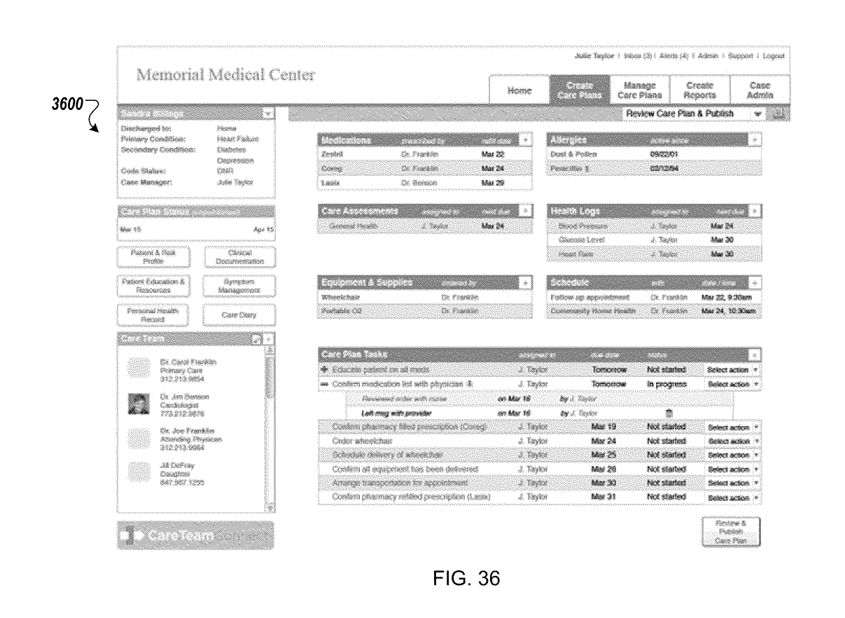

FIG. 36 is a screen shot of an alternate example web page 3600 for review of a care plan.

FIG. 37 is a screen shot of an example web page 3700 for a home web page for a case manager.

FIG. 38 is a screen shot of an example web page 3800 for an inbox for a case manager.

FIG. 39 is a screen shot of an example web page 3900 that lists reminders and alerts for a case manager.

FIG. 40 is a screen shot of an alternate example web page 4000 that lists reminders and alerts for a case manager.

FIG. 41 is a screen shot of an example web page 4100 that includes a medication list 4102 for a patient.

FIG. 42A is a screen shot of an example web page 4200 that shows a care plan summary for a patient.

FIG. 42B is a screen shot of an alternate example web page 4250 that shows a care plan summary for a patient.

FIG. 43 is a screen shot of an example web page 4300 that includes detailed information associated with a task.

FIG. 44 is a screen shot of an example web page 4400 that includes information for one or more care team members.

FIG. 45 is a screen shot of an example web page 4500 for a family portal.

FIG. 46 is a screen shot of an example web page 4600 that includes an outcome report for patient readmissions.

FIG. 47 is a screen shot of an example web page 4700 that includes a readmission summary for patient readmissions.

FIG. 48 is a screen shot of an example web page 4800 that includes a condition summary for patient readmissions.

FIG. 49 is a screen shot of an example web page 4900 that includes a case status report for patient readmissions.

FIG. 50 is a screen shot of an example web page 5000 that includes a contact history report.

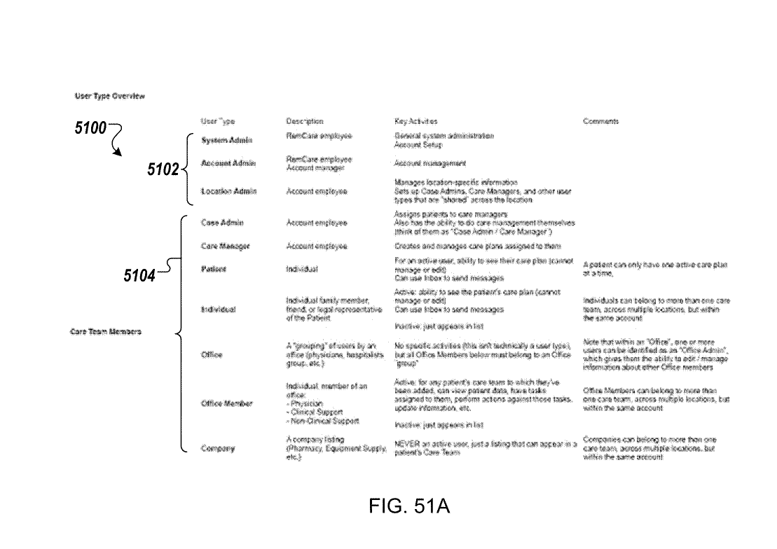

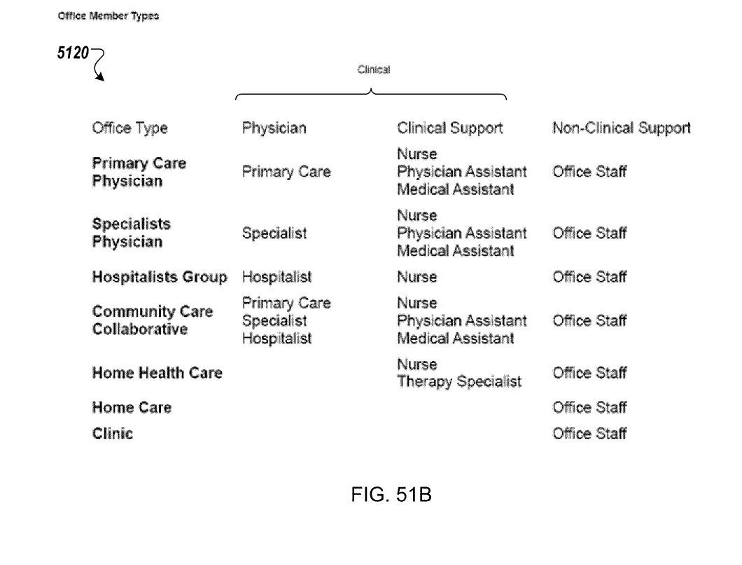

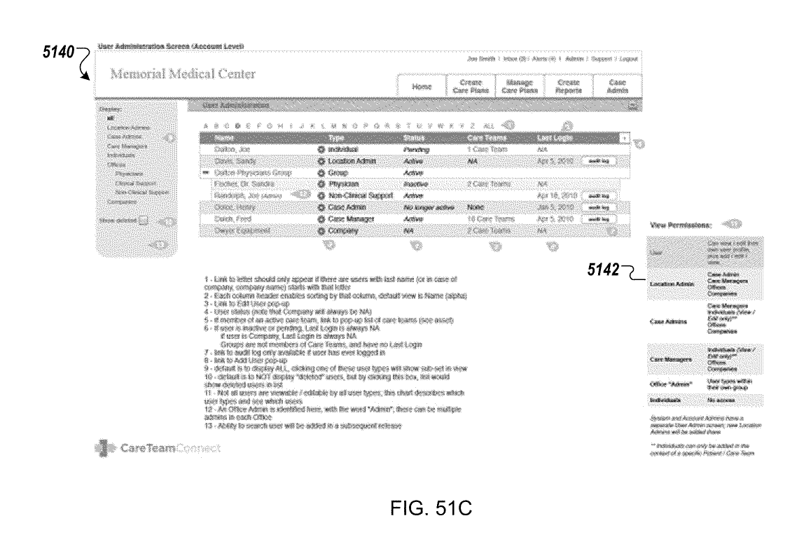

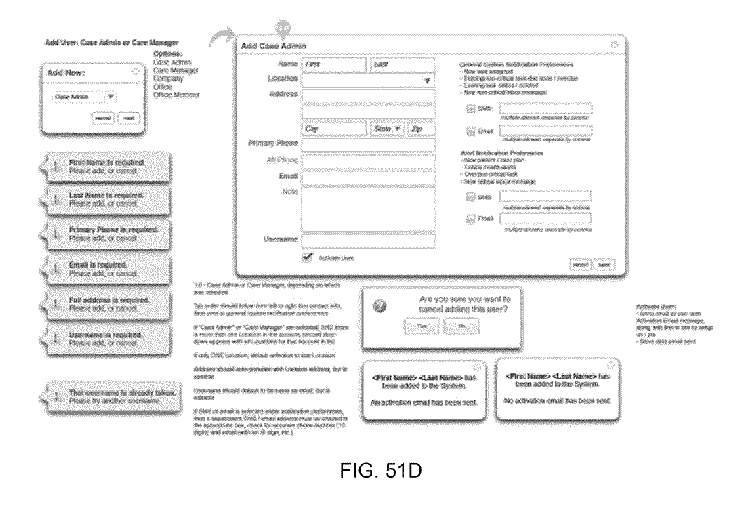

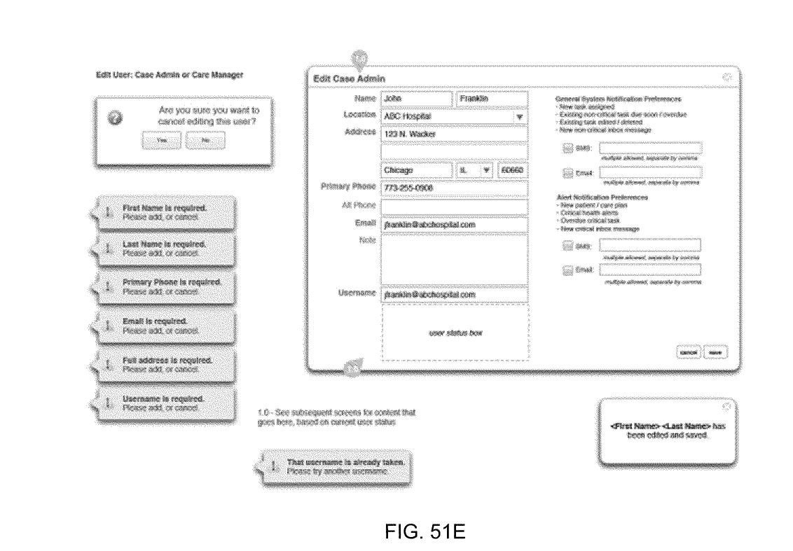

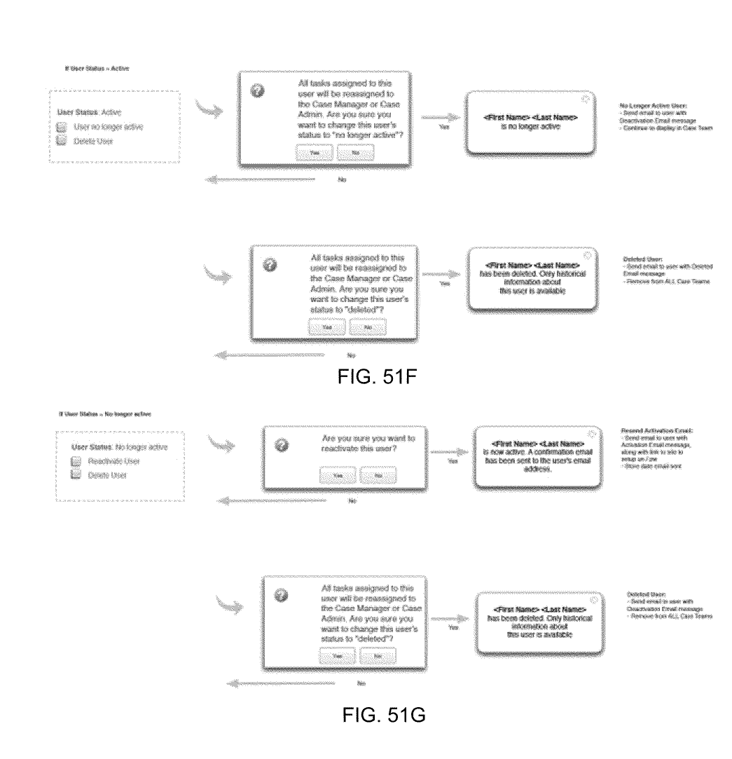

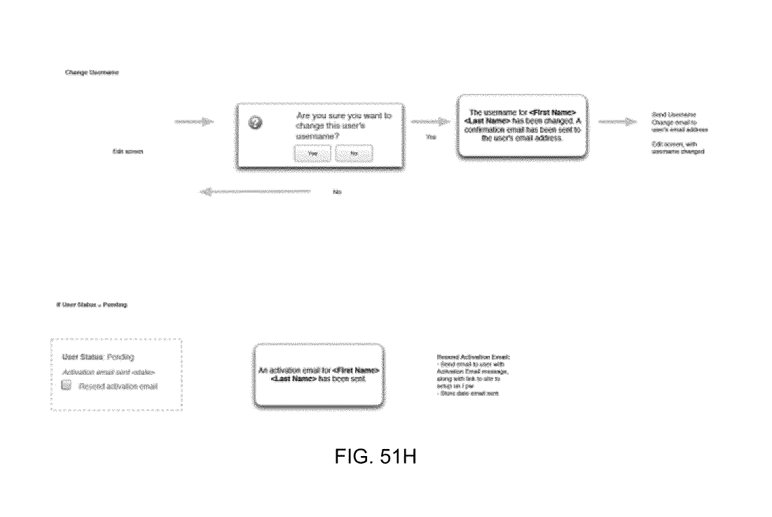

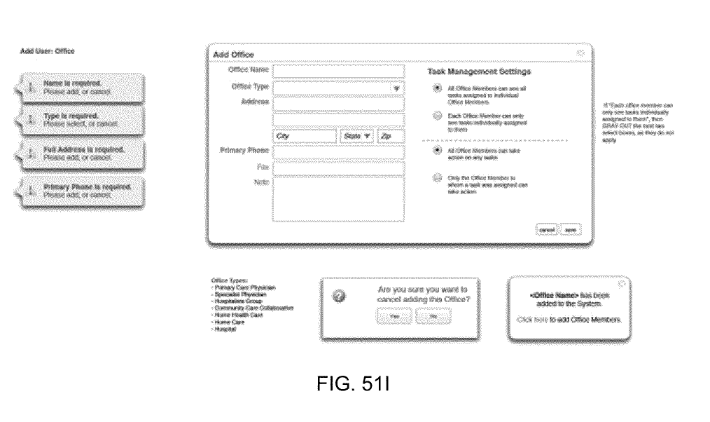

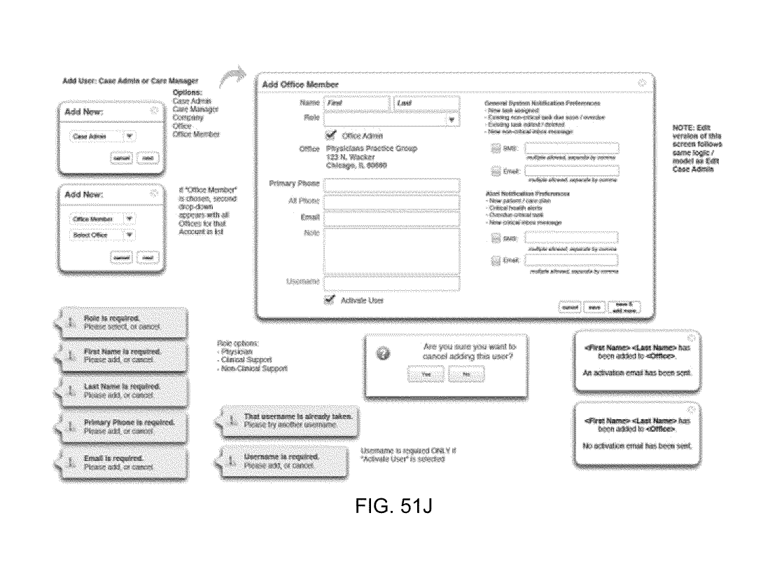

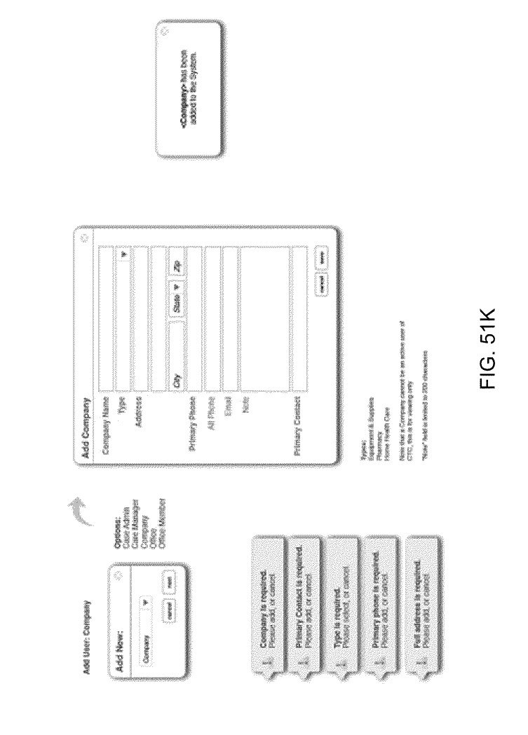

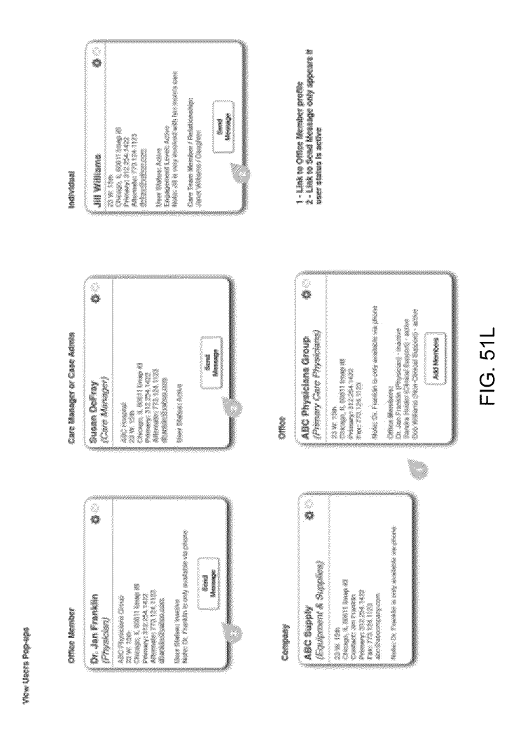

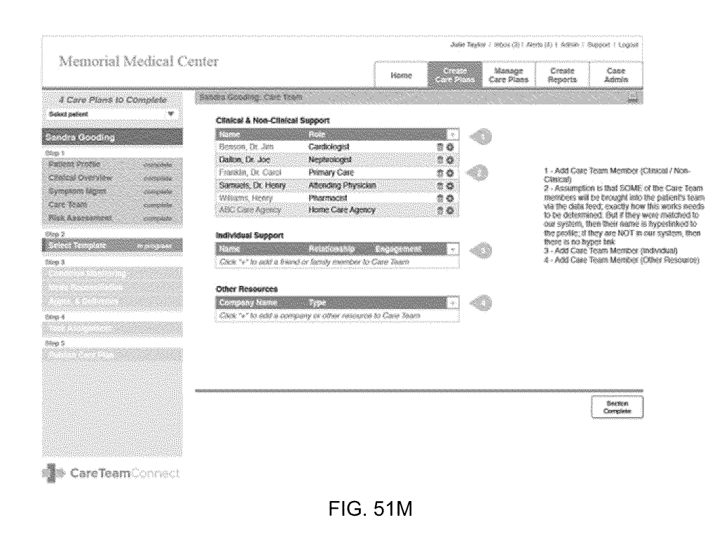

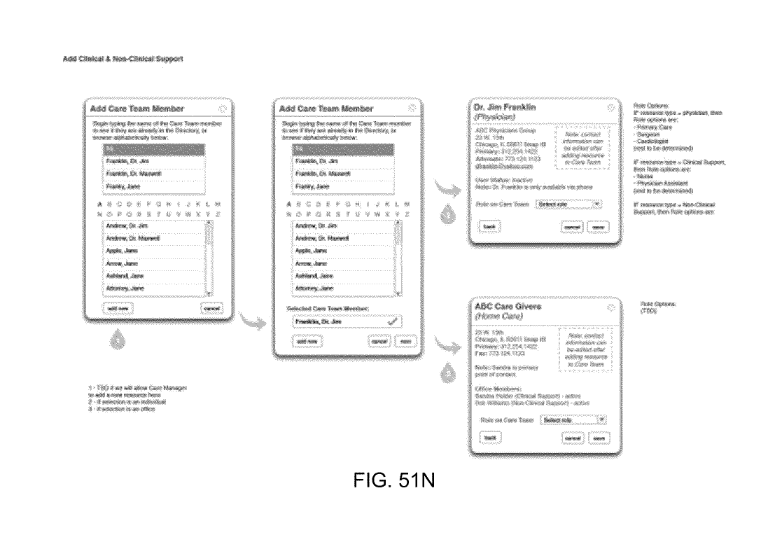

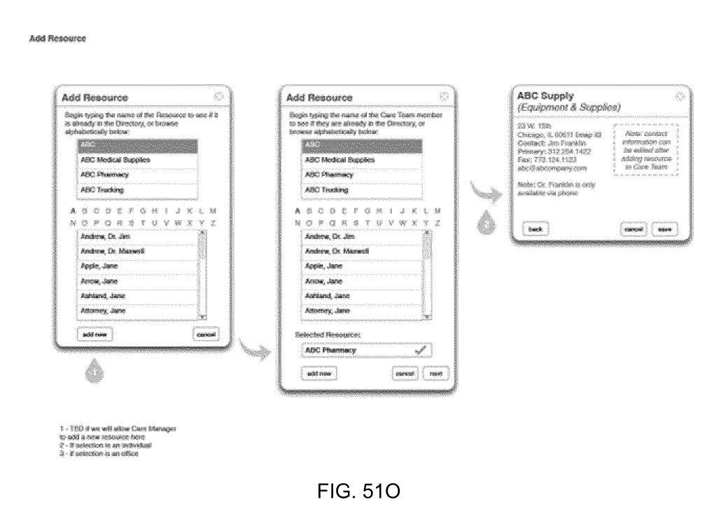

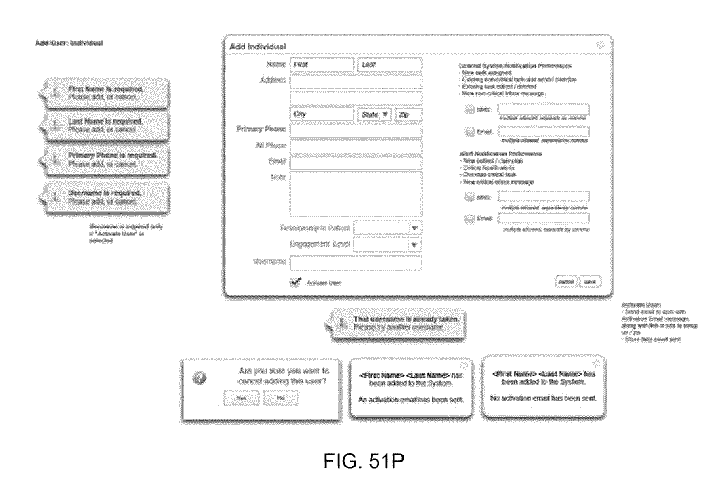

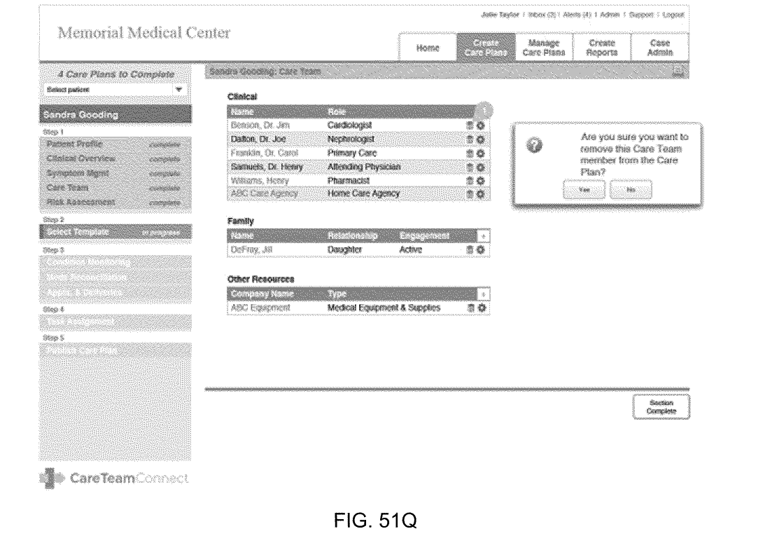

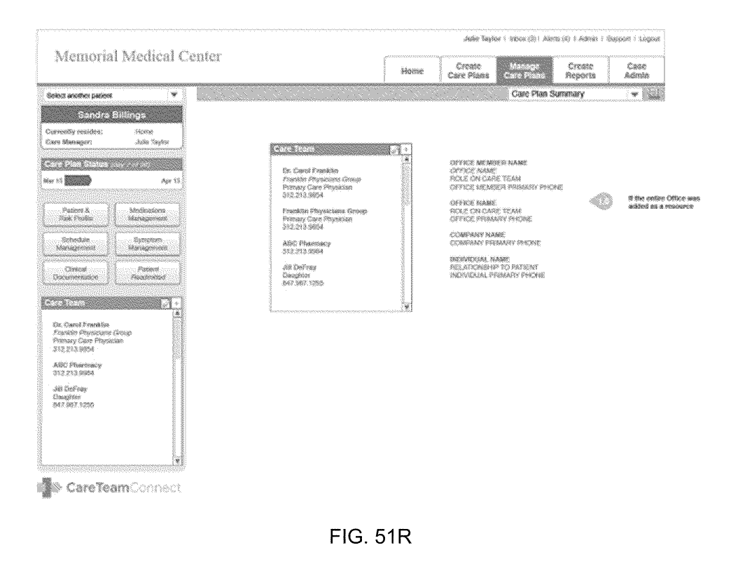

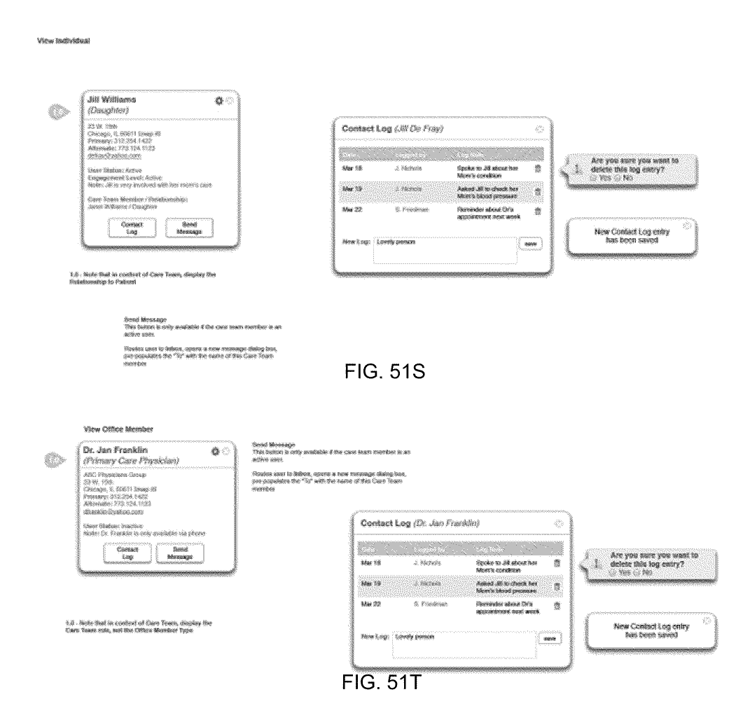

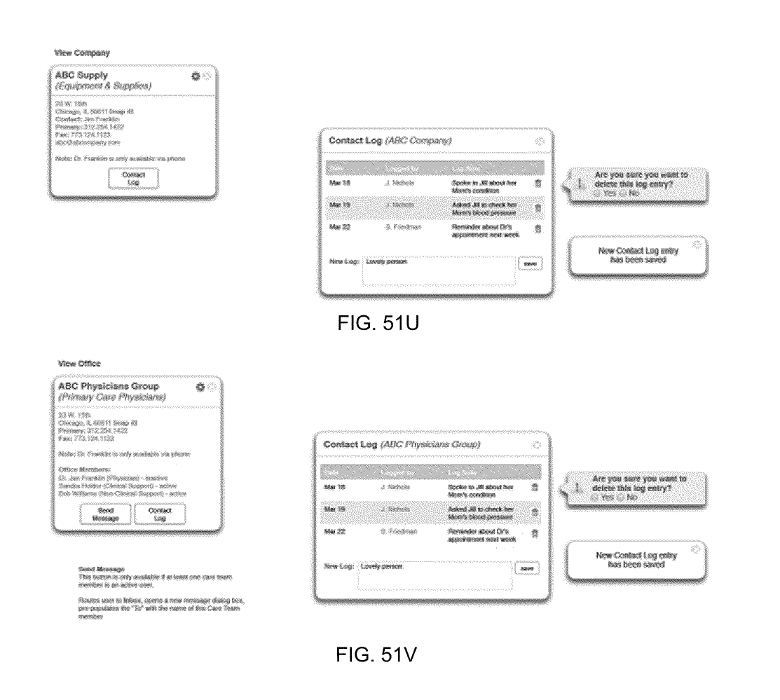

FIG. 51A is a chart of an example of a user type overview 5100. The overview 5100 includes the type of user that may be included in a patient care plan, a description of the user and the key activities performed by the user. The types of users can include administrators 5102 and care team members 5104. The types of administrators 5102 can include but are not limited to system administrators, account managers and location administrators. The types of care team members 5104 can include but are not limited to case administrators, care managers, individuals (e.g., a family member), offices (e.g., a group of physicians in an physician's office), office members (e.g., an individual member of an office), and companies (e.g., a pharmacy, medical equipment supplier, etc.). FIG. 51B is a chart of an example listing of office member types 5120 that includes clinical and non-clinical support members.

FIGS. 51C-51V are screen shots of example web pages for adding and managing care team members and resources. In some implementations, the access permissions to a patient care plan are based on the type of user. For example, a location administrator assigns specific access permissions to each user type. Additionally, specific care team members can assign specific access permissions to other care team members. Referring to FIG. 51C, a user administration screen web page 5140 includes a permissions chart 5142 indicating the user type and associated permissions the user can grant to other user types. For example, referring to FIGS. 51D-51a care manager can grant access rights to a patient care plan to offices and companies.

Referring to FIGS. 51D, 51E, 51I-51K, a case administrator or care manager can add a new user to the care team or edit the data for an existing user. Referring to FIGS. 51F-51H the status of a user is determined. An active user can be changed to inactive and their tasks can be reassigned. An inactive user can be reactivated. A user can be deleted. Additionally, a username can be changed. FIGS. 51M-51P show web pages that enable a case manager to assign care team members according to user type to a patient care plan. FIG. 51Q shows a web page that enables a case manager to remove a care team member from a patient care plan. The ability of a case manager to activate, deactivate, delete and remove care team members can be based in the access permissions given to the care manager.

As previously described, case administrators, case managers, and other user types such as individuals and office members can navigate to a web page for a hospital (e.g., web page 400 as shown in FIG. 4) that includes a login window. The user can enter their user credentials (e.g., username and password) to login to the care team connection portal associated with the hospital. One or more higher level users with the appropriate permissions have set the user's access privileges. For example, a patient's daughter (an individual user type) logs into the care team connection portal associated with the hospital and is given permission to view the patient care plan for her mother. She has no additional access rights to any other patient care plans. Additionally, she is able to view that care plan but does not have access rights to edit the care plan. In another example, a case manager logs into the care team connection portal associated with the hospital and is given permission to view the patient care plan for each patient assigned to them by the case administrator. Additionally, the case manager can view and edit the patient care plan for patients assigned to them. However, the case manager cannot view the care plans of any patients not assigned to them.

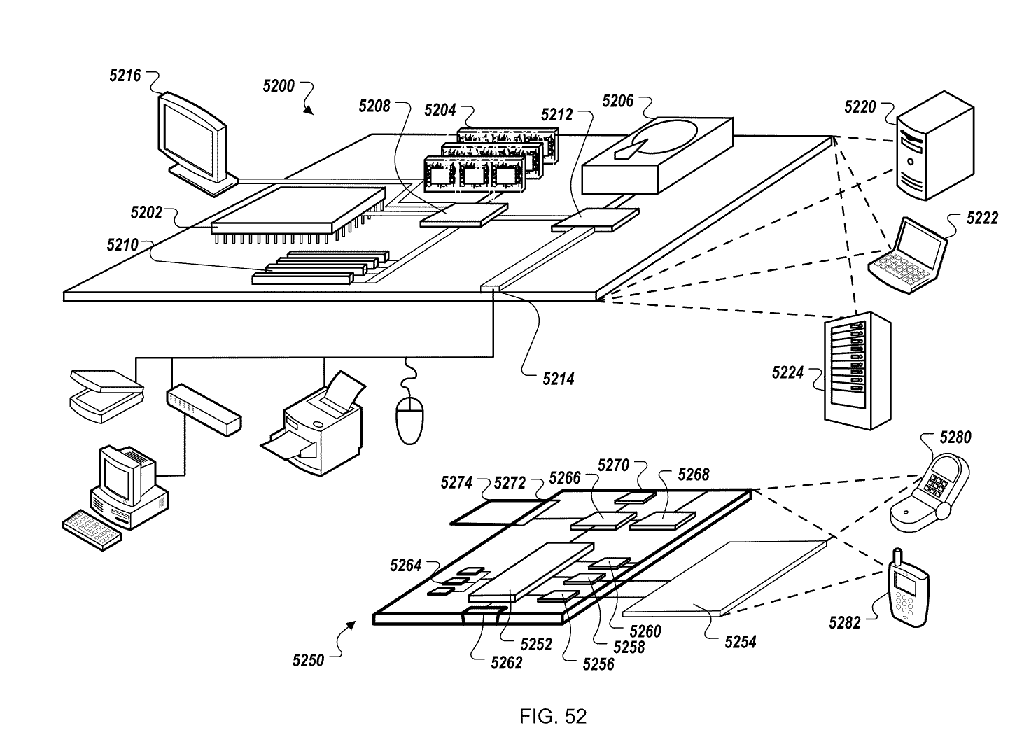

FIG. 52 is a block diagram of computing devices 5200, 5250 that may be used to implement the systems and methods described in this document, either as a client or as a server or plurality of servers. Computing device 5200 is intended to represent various forms of digital computers, such as laptops, desktops, workstations, personal digital assistants, servers, blade servers, mainframes, and other appropriate computers. Computing device 5250 is intended to represent various forms of mobile devices, such as personal digital assistants, cellular telephones, smart phones, and other similar computing devices. The components shown here, their connections and relationships, and their functions, are meant to be exemplary only.

Computing device 5200 includes a processor 5202, memory 5204, a storage device 5206, a high-speed interface 5208 connecting to memory 5204 and high-speed expansion ports 5210, and a low speed interface 5212 connecting to low speed bus 5214 and storage device 5206. Each of the components 5202, 5204, 5206, 5208, 5210, and 5212, are interconnected using various busses, and may be mounted on a common motherboard or in other manners as appropriate. The processor 5202 can process instructions for execution within the computing device 5200, including instructions stored in the memory 5204 or on the storage device 5206 to display graphical information for a graphical user interface (GUI) on an external input/output device, such as display 5216 coupled to high speed interface 5208. In other implementations, multiple processors and/or multiple buses may be used, as appropriate, along with multiple memories and types of memory. Also, multiple computing devices 5200 may be connected, with each device providing portions of the necessary operations (e.g., as a server bank, a group of blade servers, or a multi-processor system).

The memory 5204 stores information within the computing device 5200. In one implementation, the memory 5204 is a computer-readable medium. In one implementation, the memory 5204 is a volatile memory unit or units. In another implementation, the memory 5204 is a non-volatile memory unit or units.

The storage device 5206 is capable of providing mass storage for the computing device 5200. In one implementation, the storage device 5206 is a computer-readable medium. In various different implementations, the storage device 5206 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 5204, the storage device 5206, and/or memory on processor 5202.

The high speed controller 5208 manages bandwidth-intensive operations for the computing device 5200, while the low speed controller 5212 manages lower bandwidth-intensive operations. Such allocation of duties is exemplary only. In one implementation, the high-speed controller 5208 is coupled to memory 5204, display 5216 (e.g., through a graphics processor or accelerator), and to high-speed expansion ports 5210, which may accept various expansion cards (not shown). In the implementation, low-speed controller 5212 is coupled to storage device 5206 and low-speed expansion port 5214. The low-speed expansion port, which may include various communication ports (e.g., Universal Serial Bus (USB), Bluetooth, Ethernet, wireless Ethernet) may be coupled to one or more input/output devices, such as a keyboard, a pointing device, a scanner, or a networking device such as a switch or router, e.g., through a network adapter.

The computing device 5200 may be implemented in a number of different forms, as shown in the figure. For example, it may be implemented as a standard server 5220, or multiple times in a group of such servers. It may also be implemented as part of a rack server system 5224. In addition, it may be implemented in a personal computer such as a laptop computer 5222. Alternately, components from computing device 5200 may be combined with other components in a mobile device (not shown), such as device 5250. Each of such devices may contain one or more of computing device 5200, 5250, and an entire system may be made up of multiple computing devices 5200, 5250 communicating with each other.

Computing device 5250 includes a processor 5252, memory 5264, an input/output device such as a display 5254, a communication interface 5266, and a transceiver 5268, among other components. The device 5250 may also be provided with a storage device, such as a microdrive or other device, to provide additional storage. Each of the components 5250, 5252, 5264, 5254, 5266, and 5268, are interconnected using various buses, and several of the components may be mounted on a common motherboard or in other manners as appropriate.

The processor 5252 can process instructions for execution within the computing device 5250, including instructions stored in the memory 5264. The processor may also include separate analog and digital processors. The processor may provide, for example, for coordination of the other components of the device 5250, such as control of user interfaces, applications run by device 5250, and wireless communication by device 5250.

Processor 5252 may communicate with a user through control interface 5258 and display interface 5256 coupled to a display 5254. The display 5254 may be, for example, a thin film transistor liquid crystal (TFT LCD) display or an organic light emitting diode (OLED) display, or other appropriate display technology. The display interface 5256 may comprise appropriate circuitry for driving the display 5254 to present graphical and other information to a user. The control interface 5258 may receive commands from a user and convert them for submission to the processor 5252. In addition, an external interface 5262 may be provide in communication with processor 5252, so as to enable near area communication of device 5250 with other devices. External interface 5262 may provide, for example, for wired communication (e.g., via a docking procedure) or for wireless communication (e.g., via Bluetooth or other such technologies).

The memory 5264 stores information within the computing device 5250. In one implementation, the memory 5264 is a computer-readable medium. In one implementation, the memory 5264 is a volatile memory unit or units. In another implementation, the memory 5264 is a non-volatile memory unit or units. Expansion memory 5274 may also be provided and connected to device 5250 through expansion interface 5272, which may include, for example, a single in-line memory module (SIMM) card interface. Such expansion memory 5274 may provide extra storage space for device 5250, or may also store applications or other information for device 5250. Specifically, expansion memory 5274 may include instructions to carry out or supplement the processes described above, and may include secure information also. Thus, for example, expansion memory 5274 may be provide as a security module for device 5250, and may be programmed with instructions that permit secure use of device 5250. In addition, secure applications may be provided via the SIMM cards, along with additional information, such as placing identifying information on the SIMM card in a non-hackable manner.

The memory may include for example, flash memory and/or Magnetoresistive Random Access Memory (MRAM) memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 5264, expansion memory 5274, memory on processor 5252, or a propagated signal.

Device 5250 may communicate wirelessly through communication interface 5266, which may include digital signal processing circuitry where necessary. Communication interface 5266 may provide for communications under various modes or protocols, such as Global System for Mobile (GSM) voice calls, SMS, Enhanced Messaging Service (EMS), or Multimedia Messaging Service (MMS) messaging, Code Division Multiple Access (CDMA), Time Division Multiple Access (TDMA), Private Data Channel (PDC), Wideband Code Division Multiple Access (WCDMA), Code Division Multiple Access 2000 (CDMA2000), or General Packet Radio Service (GPRS), among others. Such communication may occur, for example, through radio-frequency transceiver 5268. In addition, short-range communication may occur, such as using a Bluetooth, WiFi, or other such transceiver (not shown). In addition, Global Positioning System (GPS) receiver module 5270 may provide additional wireless data to device 5250, which may be used as appropriate by applications running on device 5250.

Device 5250 may also communication audibly using audio codec 5260, which may receive spoken information from a user and convert it to usable digital information. Audio codex 5260 may likewise generate audible sound for a user, such as through a speaker, e.g., in a handset of device 5250. Such sound may include sound from voice telephone calls, may include recorded sound (e.g., voice messages, music files, etc.) and may also include sound generated by applications operating on device 5250.

The computing device 5250 may be implemented in a number of different forms, as shown in the figure. For example, it may be implemented as a cellular telephone 5280. It may also be implemented as part of a smart phone 5282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and can be implemented in a high-level procedural and/or object-oriented programming language, and/or in assembly/machine language.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a GUI or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method for managing the care of a patient, comprising:
receiving patient data at a computing device, the patient data comprising data regarding a condition of the patient and at least a portion of the patient data being transmitted to the computing device from a clinical information system over a network;
determining a patient risk level based on the patient data;
generating a patient care plan based on the patient data, the patient care plan comprising one or more tasks, the one or more tasks based on the patient risk level;
receiving user input at the computing device;
assigning a care team comprising one or more members based on the user input, each member responsible for execution of at least one of the one or more tasks;
generating at least one required action corresponding to each of the one or more tasks;
transmitting the at least one required action to a remote computing device associated with a member that is responsible for execution of a task related to the at least one required action; and
monitoring execution of the one or more tasks based on task data received at the computing device.

2. The method of claim 1, wherein monitoring comprises:
tracking completion of the one or more tasks based on the task data, the task data comprising one or more indictors related to performance of the one or more tasks; and
generating a report, the report comprising resultant data related to the care of the patient.

3. The method of claim 1, wherein the patient data further comprises patient demographic data.

4. The method of claim 3, further comprising receiving the demographic data from one of an admissions, discharges, and transfers (ADT) Health Level 7 (HL7) interface, a medications interface and a discharge summary interface.

5. The method of claim 1, wherein the patient data further comprises patient cognitive ability.

6. The method of claim 1, further comprising determining a patient self care ability based on the patient data, wherein the patient care plan is determined based at least in part on the patient self care ability.

7. The method of claim 1, wherein monitoring comprises receiving the task data as at least one of an electronic mail message, and a Short Message Service (SMS) message transmitted from the remote computing device.

8. The method of claim 1, further comprising:
generating a reminder at the computing device based on a due date of at least one of the one or more tasks; and
transmitting the reminder to the remote computing device over the network.

9. The method of claim 1, further comprising:
generating an alert indicating that one or more of the tasks was not performed within a predetermined time; and
displaying the alert at the computing device.

10. The method of claim 1, wherein the care team comprises one or more medical doctors, nurses, home healthcare nurses, community providers, community members or family members.

11. The method of claim 1, wherein the care plan comprises medication schedules, condition monitoring, physician appointments or patient education.

12. The method of claim 1, wherein the patient data further comprises data manually entered into the computing device.

13. The method of claim 1, wherein the patient is an inpatient in a hospital.

14. The method of claim 1, wherein the patient care plan comprises a post-discharge care plan.

15. The method of claim 1, further comprising assigning a case manager responsible for execution of the patient care plan based on user input received at the computing device.

16. The method of claim 15, wherein the case manager is affiliated with a hospital responsible for care of the patient.

17. The method of claim 1, further comprising generating resultant data including hospital readmission data.

18. The method of claim 1, wherein generating the patient care plan comprises selecting the patient care plan from a plurality of patient care plans stored in a computer-readable storage medium based on the patient data.

19. The method of claim 18, wherein selecting the patient care plan comprises selecting a care plan template based on one or more medical conditions.

20. The method of claim 1, wherein generating the patient care plan comprises modifying the patient care plan based on user input received at the computing device.

21. The method of claim 1, further comprising selecting one or more of the members based on member data stored in a computer-readable storage medium.

22. A computer-readable storage device encoded with a computer program comprising instructions that, when executed, operate to cause one or more processors to perform operations comprising:
receiving patient data at a computing device, the patient data comprising data regarding a condition of the patient and at least a portion of the patient data being transmitted to the computing device from a clinical information system over a network;
determining a patient risk level based on the patient data;
generating a patient care plan based on the patient data, the patient care plan comprising one or more tasks, the one or more tasks based on the patient risk level;
receiving user input at the computing device;
assigning a care team comprising one or more members based on the user input, each member responsible for execution of at least one of the one or more tasks;
generating at least one required action corresponding to each of the one or more tasks;
transmitting the at least one required action to a remote computing device associated with a member that is responsible for execution of a task related to the at least one required action; and
monitoring execution of the one or more tasks based on task data received at the computing device.

23. A system comprising:
a computing device comprising one or more processors; and
a computer-readable storage device coupled to the one or more processors and having instructions stored thereon which, when executed by the one or more processors, causes the one or more processors to perform operations comprising:
receiving patient data, the patient data comprising data regarding a condition of the patient and at least a portion of the patient data being transmitted to the computing device from a clinical information system over a network;
determining a patient risk level based on the patient data;
generating a patient care plan based on the patient data, the patient care plan comprising one or more tasks, the one or more tasks based on the patient risk level;
receiving user input;
assigning a care team comprising one or more members based on the user input, each member responsible for execution of at least one of the one or more tasks;
generating at least one required action corresponding to each of the one or more tasks;
transmitting the at least one required action to a remote computing device associated with a member that is responsible for execution of a task related to the at least one required action; and
monitoring execution of the one or more tasks based on task data received at the computing device.
